(19) United States
(12) Patent Application Publication
(10) Pub. No.: US 2005/0253773 A1
(43) Pub. Date: Nov. 17, 2005

(54) Display

(76) Inventor: Kanetaka Sekiguchi, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/529,259

(22) PCT Filed: Sep. 25, 2003
(86) PCT No.: PCT/JP03/12282

§ 371 Date: Mar. 25, 2005

(30) Foreign Application Priority Data
Sep. 25, 2002 (JP) 2002-279115

(51) Int. Cl. G09G 5/00

(52) U.S. Cl. 345/1.1

(57) ABSTRACT

To reduce the number of panel driving circuits of a display apparatus having a plurality of display panels, and to minimize the mounting area of the display apparatus, a display apparatus with two kinds of display panels of a first display panel (4) and a second display panel (5) includes a driving circuit mounted on the first display panel (4). A driving signal from the driving circuit is transmitted to the second display panel (5) via an electrode provided on the first display panel (4). An inter-panel switching element is provided between the first display panel (4) and the second display panel (5), thereby controlling turning passage and non-passage of the second display panel (5).

### TECHNICAL FIELD

The present invention provides a display apparatus having two active matrix liquid crystal display panels, with a switching element provided on each pixel unit, where a second display panel can be driven via an electrode provided on a substrate of a first display panel.

The present invention also provides a configuration that has, on at least one of a first substrate and a second substrate, an inter-panel switching element which controls passage and non-passage of a signal between an electrode provided on the first substrate and an electrode provided on the second substrate based on presence or absence of display of the second display panel, thereby saving unnecessary display of a display panel and reducing power consumption.

The present invention also provides a display apparatus that has a protection element which prevents degradation of a liquid crystal due to static electricity or prevents degradation of a switching element, on any one of the substrates constituting the first display panel and the second display panel, near an inter-panel connector connecting the first display panel and the second display panel.

The present invention also provides a display apparatus that has an active matrix display panel and a passive matrix display panel, and that converts a signal for driving a display panel of either one of the driving systems, thereby driving a display panel of the other driving system.

The present invention also provides a display apparatus that has a liquid crystal display panel and a display panel utilizing an organic light-emitting diode (organic LED), that is, organic electroluminescence (organic EL), (hereinafter, “organic LED display panel”), wherein the display apparatus converts a signal for driving the liquid crystal display panel, thereby driving the organic LED display panel, or converts a signal for driving the organic LED display panel, thereby driving the liquid crystal display panel.

### BACKGROUND ART

At present, because of advantages of light weight, low power consumption, and reflection display, a liquid crystal display panel is widely used for portable information apparatuses. Because display contents are wide-ranging, a matrix liquid crystal display panel is mainly used. Particularly, from the viewpoint of a display quality, development of an active matrix liquid crystal display panel having a switching element formed for each pixel has been progressed.

For example, the active matrix liquid crystal display panel is configured such that a gate electrode disposed in an x direction and a source electrode disposed in a y direction, and a thin-film transistor (TFT) element disposed at a cross point of these electrodes, are provided on a first substrate, and that a display electrode is connected to a drain electrode of the thin-film transistor.

A common electrode is provided on a second substrate facing the first substrate on which the thin-film transistor is provided, and a liquid crystal is sealed in a gap between the first substrate and the second substrate, thereby forming the active matrix liquid crystal display panel.

An ON voltage is applied to the gate electrode, a data signal is applied to the source electrode, and a predetermined voltage difference is provided between the display electrode and the common electrode, thereby applying a predetermined voltage to the liquid crystal to achieve an on-display.

On the other hand, when an OFF voltage is applied to the gate electrode to set the switching element to an off state, and when a data signal is applied to the source electrode, an on-display or an off-display can be maintained, because of no occurrence of a voltage difference between the display electrode and the common electrode. With the above arrangement, when the on/off signals to be applied to the gate electrode and the signal to be applied to the source electrode are switched occasionally, a video display becomes possible.

A portable telephone has a large display screen along the increase in the amount of information of Internet connection display contents and e-mail display contents. A foldable portable telephone is available to prevent an erroneous operation of buttons during a non-use time. The foldable portable telephone has a sub liquid crystal display panel provided on a front cover, because display contents of a main liquid crystal display panel cannot be recognized when it is folded. By the provision of the sub liquid crystal display panel, limited information can be displayed even when it is folded.

The configuration of the foldable portable telephone is explained with reference to FIGS. 1 and 2. FIG. 1 is a perspective view of a portable telephone, with a cover of the portable telephone opened, and a main liquid crystal display panel (a first display panel) displays characters and an image. FIG. 2 is a perspective view of the portable telephone, with the cover of the portable telephone closed, and a sub liquid crystal display panel (a second display panel) displays characters and an image, with the main liquid crystal display panel set as non-display.

As shown in FIG. 1, a portable telephone main unit 102 is provided with plural input buttons 104 to input numerals or characters, to select a mode, to switch a power source, and to scroll a screen, and a microphone 107. A portable telephone cover 101 is disposed with a first display panel 4 and a second display panel 5 on opposite sides, respectively, and a speaker 106 is provided on the first display panel 4 side.

The first display panel 4 displays communication contents, e-mail contents, Internet information, telephone numbers, remaining battery level, a receiving status, and necessary information for the user, as contents displayed on the first display panel 4.

An antenna 103 and an imaging element 108 are provided on the back side of the portable telephone cover 101. When the back side of the portable telephone cover 101 is closed, the second display panel 5 turns to a display state, and a backlight (not shown) is lit according to needs. The second display panel 5 displays an imaging status of the imaging element 108, e-mail reception information, a receiving status, remaining battery level, and portable telephone information. In general, a display capacity of the second display panel 5 is smaller than that of the first display panel 4.

However, the first display panel 4 that constitutes the main liquid crystal display panel requires a driving circuit, and the second display panel 5 that constitutes the sub liquid crystal display panel also requires an independent driving circuit. Because of the provision of the independent driving circuits, the driving circuits require cost, and further require installation cost and space.

Therefore, the following system has been considered. A driving circuit (a driver) is connected to one of the first display panel 4 and the second display panel 5. A common electrode is directly connected from the driving circuit to the first display panel 4 and the second display panel 5 using a flexible printed substrate (FPC). Regarding a segment electrode, a signal is applied to the segment electrode of the second display panel 5 via the electrode of the first display panel 4 (see, for example, Patent Literature 1 (Japanese Patent Application Laid-open No. 2001-67049 Publication (P.6-P.7, and FIG. 3))).

According to the Patent Literature 1, a switching element is not provided in each pixel unit. Therefore, the segment electrode is connected to the second panel 5 via a display area of the first display panel 4, and the common electrode is connected to the second panel 5 by making a detour around the display area 4 of the first display panel 4. When an active matrix liquid crystal display panel according to the present invention is used, when only a part of the electrode of the first display panel 4 is connected to the electrode of the second display panel 5, an occurrence of uneven load due to a liquid crystal of the electrode of the first display panel 4 makes no influence to the display of the second display panel. Similarly, an occurrence of uneven load due to a liquid crystal of the electrode of the second display panel 5 makes no influence to the display of the first display panel.

A configuration of driving the first display panel 4 and the second display panel 5 with an integral driving circuit, and connecting the first display panel 4 and the second display panel 5 with an inter-panel connector, is publicly known (see, for example, Patent Literature 2 (Japanese Patent Application Laid-open No. 2001-282145 Publication (P.3-P.4, and FIG. 1))). However, according to the Patent Literature 2, a method of connecting the second display panel 5 and a connection electrode of the driving circuit, and a method of connecting a column electrode or a row electrode of the first display panel 4 to the second display panel 5, are not disclosed. Therefore, the Patent Literature 2 makes no disclosure of the following techniques intended by the present invention. The present invention provides a technique of extending the electrode used in the display area of the first display panel 4, and connecting the row electrode and the column electrode to the second display panel 5, thereby reducing the number of output from the driving circuit. The present invention also provides a technique of proving an inter-panel switching element between the first display panel 4 and the second display panel 5.

A configuration of a conventional example is explained with reference to FIG. 41. FIG. 41 is a configuration diagram of a state in which two liquid crystal display panels connected to one driving circuit. A portable telephone shown in the conventional example includes a control signal block 30, a driving circuit 31, the first display panel 4, and the second display panel 5. With a signal electrode line (c_) set common, the one driving circuit 31 drives the first display panel 4 and the second display panel 5.

In other words, the driving circuit 31 controls the driving of 62 signal electrodes (c_1 to c_62) and 100 scan electrodes (r_1 to r_100), and displays targets on the first and the second display panels 4 and 5, respectively, following a control signal applied from a system controller.

The first display panel 5 includes 62 signal electrodes that are connected to the 62 signal electrodes (c_1 to c_62) respectively of the driving circuit 31, and 61 scan electrodes that are connected to r_1 to r_61 respectively out of the 100 scan electrodes (r_1 to r_100). Therefore, the first display panel 4 has 62×61 matrix pixels.

The second display panel 5 includes 62 signal electrodes that are connected to the 62 signal electrodes (c_1 to c_62) respectively of the driving circuit 31, and 39 scan electrodes that are connected to r_62 to r_100 respectively out of the 100 scan electrodes (r_1 to r_100). Therefore, the second display panel 5 has 62×39 matrix pixels.

The signal electrodes (c_1 to c_62) and the scan electrodes (r_1 to r_100) from the driving circuit 31 are connected to the first display panel 4 via an FPC 35, and are further connected to the second display panel 5 via an FPC 43.

In the conventional example, a configuration that the one driving circuit 31 drives the first display panel 4 and the second display panel 5, with a scan electrode set common, is also disclosed.

However, according to a passive matrix type as shown in the conventional example, when a part of the electrode of the first display panel 4 is connected to the electrode of the second display panel 5, the load of the electrode connected to the second display panel 5 becomes large. Therefore, there arises a difference in the rise and fall of a signal and a voltage, in comparison with the electrode not connected. As a result, a difference occurs in the contrast of display. Further, a difference occurs in the contrast of the display of the first display panel 4 depending on the display contents, that is, a so-called “crosstalk” occurs.

When the second display panel 5 is set to non-display, a signal is transmitted to the second display panel 5, because the electrode of the first display panel 4 and the electrode of the second display panel 5 are connected in low resistance. Consequently, there is a problem that the second display panel 2 consumes power.

Further, static electricity that is generated in the first display panel 4 reaches the second display panel 5 via the electrode of the first display panel 4. Therefore, there is a problem that a display quality of the second display panel 5 is also degraded.

The conventional example makes no suggestion about providing a detour in the display area of the first display panel 4 and connecting to the electrode of the second display panel 5 via the electrode provided on the first display panel 4, when driving the second display panel 5 by using the driving circuit provided on the first display panel 4.

In connecting the first display panel 4 and the second display panel 5 with the inter-panel connector, such as a flexible printed substrate, for example, the configuration of the backlight unit requires device. Particularly, it is necessary to prevent the inter-panel connector from hindering the uniformity of the backlight.

When the first display panel 4 and the second display panel 5 are of different types, for example, when the first display panel 4 is a liquid crystal display panel and the second display panel 5 is an organic LED display panel, it is necessary to convert a driving signal of the liquid crystal display panel to a signal suitable for driving the organic LED display panel, and supply the signal to the organic LED display panel. This similarly applies to a case that the first display panel 4 is an organic LED display panel and the second display panel 5 is a liquid crystal display panel.

When the driving systems are different between the first display panel 4 and the second display panel 5, for example, when the driving system of the first display panel 4 is an active matrix system and the driving system of the second display panel 5 is a passive matrix system (or vice versa), it is necessary to convert a driving signal of the first display panel 4 to a signal suitable for driving the second display panel 5, and supply the signal to the second display panel 5.

In the light of the above points, it is an object of the present invention to provide a display apparatus in which a driving circuit connected to a first display panel drives the first display panel and a second display panel, wherein a display quality is satisfactory, power consumption can be minimized, and the display apparatus is protected from static electricity, without depending on the display contents of the first display panel or the display contents of the second display panel.

It is another object of the present invention to provide a display apparatus in which a driving circuit connected to a first display panel drives the first display panel and a second display panel, wherein when one display panel is a liquid crystal display panel and the other display panel is an organic LED display panel, the same driving circuit drives both display panels.

It is still another object of the present invention to provide a display apparatus in which a driving circuit connected to a first display panel drives the first display panel and a second display panel, wherein when one display panel is a display panel of an active matrix system and the other display panel is a display panel of a passive matrix system, the same driving circuit drives both display panels.

### DISCLOSURE OF THE INVENTION

To achieve the above object, the present invention adopts display panels described below.

A display apparatus according to one aspect of the present invention includes a first display panel including a first electro-optic display medium, a first electrode-line group having a plurality of electrode lines to supply a driving signal to the first electro-optic display medium, and an active element that controls supply of the driving signal to the first electro-optic display medium; a second display panel including a second electro-optic display medium, and a second electrode-line group having a plurality of electrode lines to supply a driving signal to the second electro-optic display medium; and a connecting member that connects the first display panel and the second display panel. At least a part of the electrode lines of the first electrode-line group are connected to a part or all of the electrode lines of the second electrode-line group via the connecting member.

The display apparatus according to the present invention further includes an inter-panel switching element that is provided between the electrode lines of the first display panel and the electrode lines of the second display panel that are connected to each other, and controls passage and non-passage of the driving signal.

The display apparatus according to the present invention further includes a protection switching element that is provided between the electrode lines of the first display panel and the electrode lines of the second display panel that are connected to each other, and disperses static electricity generated in the electrode lines.

The display apparatus according to the present invention further includes an inter-panel switching element that is provided between the electrode lines of the first display panel and the electrode lines of the second display panel that are connected to each other, and controls passage and non-passage of the driving signal; and a protection switching element that is provided between the inter-panel switching element and the electrode lines of the second display panel, and disperses static electricity generated in the electrode lines.

According to the present invention, a driving circuit that supplies the driving signal is connected to the first display panel.

According to the present invention, a driving circuit that supplies the driving signal is connected to either of the first display panel and the second display panel, of which a display area is smaller.

According to the present invention, a driving circuit that supplies the driving signal is connected to the connecting member that connects the first display panel and the second display panel.

According to the present invention, a driving circuit that supplies the driving signal is connected using an anisotropic conductive-film made of an electric conductor and an adhesive.

According to the present invention, the first display panel and the second display panel are operated with different driving signals, and the inter-panel switching element includes a signal converting circuit that converts a driving signal for the first display panel into a driving signal for the second display panel.

According to the present invention, the first display panel is an active-matrix liquid-crystal-display panel, the second display panel is a passive-matrix liquid-crystal-display panel, and the inter-panel switching element includes a signal converting circuit that converts a driving signal for the first display panel into a driving signal for the second display panel.

According to the present invention, the first display panel is an active-matrix liquid-crystal-display panel, the second display panel is formed with an organic light-emitting diode, and the inter-panel switching element includes a signal converting circuit that converts a driving signal for the first display panel into a driving signal for the second display panel.

According to the present invention, the first display panel is an active-matrix display panel formed with an organic light-emitting diode, the second display panel is a passive-matrix liquid-crystal-display panel, and the inter-panel switching element includes a signal converting circuit that converts a driving signal for the first display panel into a driving signal for the second display panel.

According to the present invention, the first display panel is an active-matrix display panel formed with an organic light-emitting diode, the second display panel is an active-matrix liquid-crystal-display panel, and the inter-panel switching element includes a signal converting circuit that converts a driving signal for the first display panel into a driving signal for the second display panel.

The display apparatus according to the present invention further includes a third display panel including a third electro-optic display medium, and a third electrode-line group having a plurality of electrode lines to supply a driving signal to the third electro-optic display medium; and a second connecting member that connects the third display panel with either of the first display panel and the second display panel. A part or all of the electrode lines of the third electrode-line group are connected to the electrode lines of the first electrode-line group or the electrode lines of the second electrode-line group via the second connecting member.

The display apparatus according to the present invention further includes a fourth display panel including a fourth electro-optic display medium, and a fourth electrode-line group having a plurality of electrode lines to supply a driving signal to the fourth electro-optic display medium; and a third connecting member that connects the fourth display panel with one of the first display panel, the second display panel, and the third display panel. A part or all of the electrode lines of the fourth electrode-line group are connected to the electrode lines of the first electrode-line group, the electrode lines of the second electrode-line group, or the electrode lines of the third electrode-line group via the third connecting member.

The number of driving circuits to be mounted can be reduced, by employing a configuration in which the electrode line of the first display panel and the electrode line of the second display panel are connected via a connection member and the second display panel is driven by using a signal for driving the first display panel. When the signal for driving the first display panel is converted into a signal suitable for driving the second display panel, a passive matrix liquid crystal display panel and a display panel made of organic light-emitting diode can be driven by using a driving signal of an active matrix liquid crystal display panel. A passive matrix liquid crystal display panel and an active matrix liquid crystal display panel can be driven, by using a driving signal of the active matrix liquid crystal display panel made of organic light-emitting diode.

Both the first display panel as a main liquid crystal display panel and the second display panel as a sub liquid crystal display panel can be active matrix liquid crystal display panels. The number of driving circuits to be mounted can be reduced, by employing a configuration in which a signal from the driving circuit mounted on the first display panel is transferred to the second display panel via an electrode provided on the first display panel. Further, a satisfactory display quality can be achieved, without degrading the display quality of the first display panel based on the display contents of the second display panel, which occurs in the conventional passive matrix liquid crystal display panel.

Because the driving circuit is provided on only one of the first display panel and the second display panel, the mounting space for driving circuit can be omitted from the external peripheral part of the other liquid crystal display panel. Therefore, a length from the display area to the peripheral edge of the liquid crystal display panel can be reduced, and a so-called “narrow bezel” can be realized. As a result, the display panel can be made compact and thin. Further, because a part of the driving circuit that occupies a large proportion of the cost of the small liquid crystal display apparatus can be omitted, this has a cost reduction effect.

The electrical connection between the driving circuit mounted oh the first display panel and the electrode of the second display panel is carried out by using the electrode provided on the first display panel, and any one or two or more of an FPC, a metal thin wire electrode (wire bonding, spring probe), and a conductive rubber connector, as an inter-panel connector that is provided between the first display panel and the second display panel. This avoids the need for independently providing a driving circuit on the second display panel, and makes it possible to reduce the mounting space, to reduce thickness, and to reduce the cost of mounting the driving circuit.

Particularly, when the first display panel and the second display panel are mutually connected detouring around the backlight unit by using the flexible printed substrate, uniformity of light amount of the backlight improves, and the display panels can be easily built into portable telephones.

When the inter-panel switching element that turns on/off the display of the second display panel is provided at a part where the first display panel and the second display panel is electrically connected, the display of the second display panel can be turned off when the display is not necessary, thereby reducing power consumption. The display area and the number of display pixels of the sub liquid crystal display panel are reduced respectively as compared with those of the main liquid crystal display panel, thereby reducing power consumption.

The display area and the number of display pixels of the second display panel are made larger respectively than those of the liquid crystal display panel (the first display panel) on which the driving circuit is mounted. Plural electrodes are provided around the display area of the first display panel, and the signal of the driving circuit is transmitted to the second display panel by using the electrode detouring around the surrounding of the display area of the first display panel. The driving circuit is provided with two kinds of output blocks including a first output block that drives only the first display panel and a second output block that drives the second display panel other than the first display panel. When the display of the second display panel is turned off, only the first output block is operated, thereby reducing power consumption.

The inter-panel switching element is provided between the first display panel and the second display panel. With this arrangement, when the display of the second display panel is not necessary, the inter-panel switching element can completely stop the display of the second display panel, thereby substantially reducing power consumption. In this case, the first display panel corresponds to the sub liquid crystal display panel. Because the probability of the display panel being turned on with the cover of the portable telephone closed is high, this is a remarkably effective configuration to reduce power consumption of the portable telephone.

A protection element that prevents a reduction in the display quality of the display panel due to static electricity is provided on one of the substrate that constitutes the first display panel and the substrate that constitutes the second display panel. Because the first display panel and the second display panel are connected with the inter-panel connector, static electricity that is generated on any one of the display panels becomes a factor that degrades the display quality of the other display panel. Therefore, provision of the protection element in the present invention is more important than using the protection element for the conventional liquid crystal display panel.

Because the first display panel and the second display panel are connected with the inter-panel connector, provision of additional plural connectors is not preferable from the viewpoint of handling and occurrence of static electricity. Therefore, it is preferable that the driving circuit is mounted on the substrate that constitutes the display panel.

A light guide is provided between the first display panel and the second display panel. To have a small thickness, the light guide is preferably shared by the first display panel and the second display panel. The inter-panel connector is provided detouring around the wall surface in a cross-sectional direction of the light guide. Based on the provision of the inter-panel connector on a part on which the light source of the backlight unit is not provided, the amount of light irradiated from the backlight can be uniform, without the inter-panel connector shielding the light source. When the inter-panel connector is fixed to a part of the backlight unit with adhesive material, the inter-panel connector can be fixed stably.

When a groove is provided on a part of the external periphery of the light guide and also when the inter-panel connector is disposed in the groove, the inter-panel connector can be fixed and positioned. A reflection member is provided between the inter-panel connector and the light guide, thereby reutilizing the light transmitted through the light guide. Particularly, when a reflection plate having reflectivity equivalent to that of the sub liquid crystal display panel is provided between the inter-panel connector and the light guide, and on the external peripheral surface of the sub liquid crystal display panel, the amount of light irradiated from the backlight unit to the main liquid crystal display panel can be made remarkably uniform.

### BRIEF DESCRIPTION OF THE DRAWINGS

FIG. 1 is a perspective view of a portable telephone according to a first embodiment of the present invention, with a cover of the portable telephone opened;

FIG. 2 is a perspective view of the portable telephone according to the first embodiment, with the cover of the portable telephone closed;

FIG. 3 is a cross-section of a part of a display panel module according to the first embodiment;

FIG. 4 is a top plan view of display panels according to the first embodiment, which are developed in plane;

FIG. 5 is an enlarged top plan view of a part of a driving circuit of a first display panel according to the first embodiment;

FIG. 6 is an enlarged top plan view of a part of an inter-panel connector between the first display panel and a second display panel according to the first embodiment;

FIG. 7 is an enlarged top plan view of a part of the first display panel according to the first embodiment;

FIG. 8 is a top plan view of display panels according to a second embodiment of the present invention, which are developed in plane;

FIG. 9 is a top plan view of display panels according to a third embodiment of the present invention, which are developed in plane;

FIG. 10 is an equivalent circuit diagram of a part of a pixel unit of a first display panel and an inter-panel switching element according to the third embodiment;

FIG. 11 is a top plan view of display panels according to a fourth embodiment of the present invention, which are developed in plane;

FIG. 12 is a top plan view of display panels according to a fifth embodiment of the present invention, which are developed in plane;

FIG. 13 is a cross-section of a part of a display panel module according to the fifth embodiment;

FIG. 14 is an equivalent circuit diagram of a part of a pixel unit of a first display panel, an inter-panel switching element, and a protection element according to the fifth embodiment;

FIG. 15 is a system block diagram of a portable telephone according to the fifth embodiment;

FIG. 16 is a schematic top plan view of another example of the display panels according to the first embodiment, which are developed in plane;

FIG. 17 is a top plan view of a main part of display panels according to a sixth embodiment of the present invention, which is developed in plane;

FIG. 18 is a top plan view of a main part of display panels according to a seventh embodiment of the present invention, which is developed in plane;

FIG. 19 is a schematic top plan view of the display panels according to the seventh embodiment, which are developed in plane;

FIG. 20 is a cross-section of a part of a display panel module according to the seventh embodiment;

FIG. 21 is a schematic top plan view of display panels according to an eighth embodiment of the present invention, which are developed in plane;

FIG. 22 is a top plan view of a main part of display panels according to a ninth embodiment of the present invention, which is developed in plane;

FIG. 23 is a schematic top plan view of the display panels according to the ninth embodiment, which are developed in plane;

FIG. 24 is a schematic top plan view of display panels according to tenth to thirteenth embodiments of the present invention, which are developed in plane;

FIG. 25 is a waveform diagram for explaining a signal conversion between display panels according to the tenth embodiment;

FIG. 26 is a block diagram of a schematic configuration of an inter-panel switching element that converts a signal between the display panels according to the tenth embodiment;

FIG. 27 is a block diagram of a schematic configuration of an inter-panel switching element that converts a signal between the display panels according to the tenth embodiment;

FIG. 28 is an enlarged cross-section of a part of an organic LED display panel according to the eleventh and subsequent embodiments of the present invention;

FIG. 29 is a waveform diagram for explaining a signal conversion between display panels according to the eleventh embodiment;

FIG. 30 is a block diagram of a schematic configuration of an inter-panel switching element that converts a signal between the display panels according to the eleventh embodiment;

FIG. 31 is a block diagram of a schematic configuration of an inter-panel switching element that converts a signal between the display panels according to the eleventh embodiment;

FIG. 32 is a waveform diagram for explaining a signal conversion between display panels according to the twelfth embodiment;

FIG. 33 is a block diagram of a schematic configuration of an inter-panel switching element that converts a signal between the display panels according to the twelfth embodiment;

FIG. 34 is a block diagram of a schematic configuration of an inter-panel switching element that converts a signal between the display panels according to the twelfth embodiment;

FIG. 35 is a waveform diagram for explaining a signal conversion between display panels according to the thirteenth embodiment;

FIG. 36 is a block diagram of a schematic configuration of an inter-panel switching element that converts a signal between the display panels according to the thirteenth embodiment;

FIG. 37 is a block diagram of a schematic configuration of an inter-panel switching element that converts a signal between the display panels according to the thirteenth embodiment;

FIG. 38 is a schematic top plan view of display panels according to a fourteenth embodiment of the present invention, which are developed in plane;

FIG. 39 is a schematic top plan view of display panels according to a fifteenth embodiment of the present invention, which are developed in plane;

FIG. 40 is a perspective view of a portable telephone according to the fifteenth embodiment, with the cover of the portable telephone opened; and

FIG. 41 is a top plan view of display panels according to a conventional technique, which are developed in plane.

### BEST MODE FOR CARRYING OUT THE INVENTION

Exemplary embodiments of a display apparatus according to the present invention will be described in detail below with reference to the accompanying drawings.

(Configuration of Electrode Wiring Between Two Display Panels)<

### First Embodiment

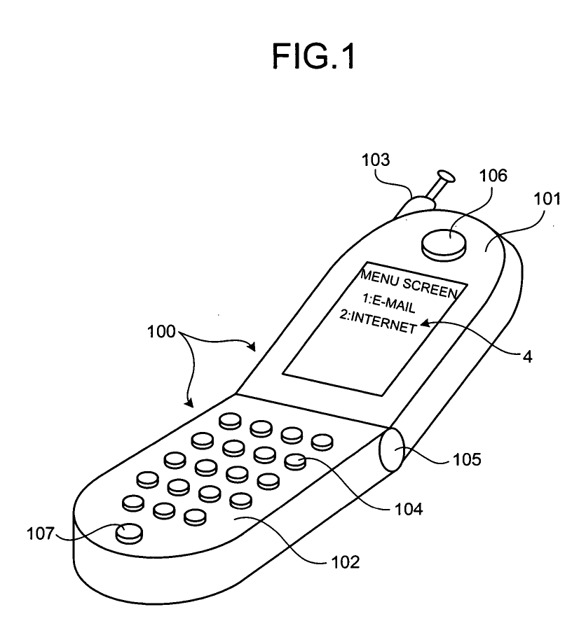

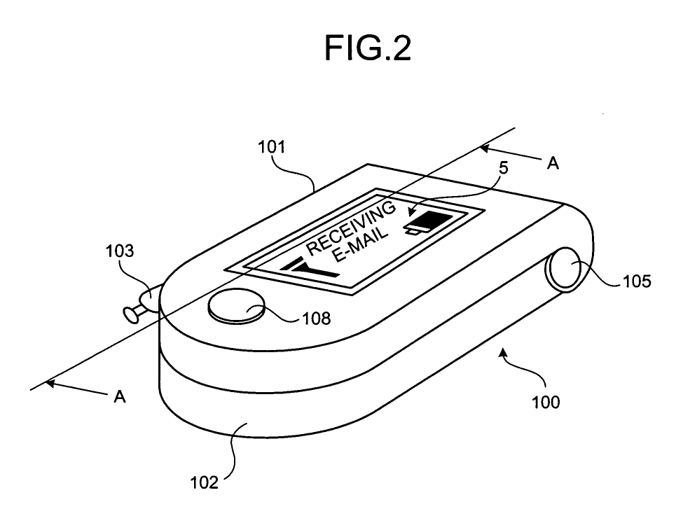

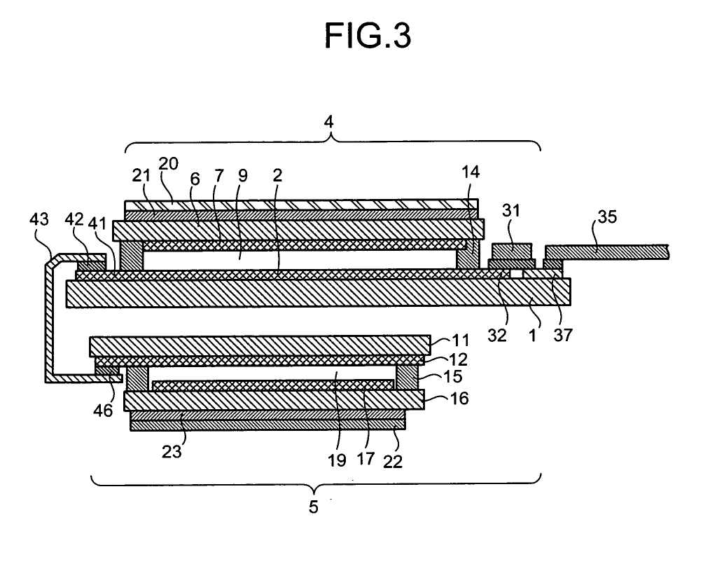

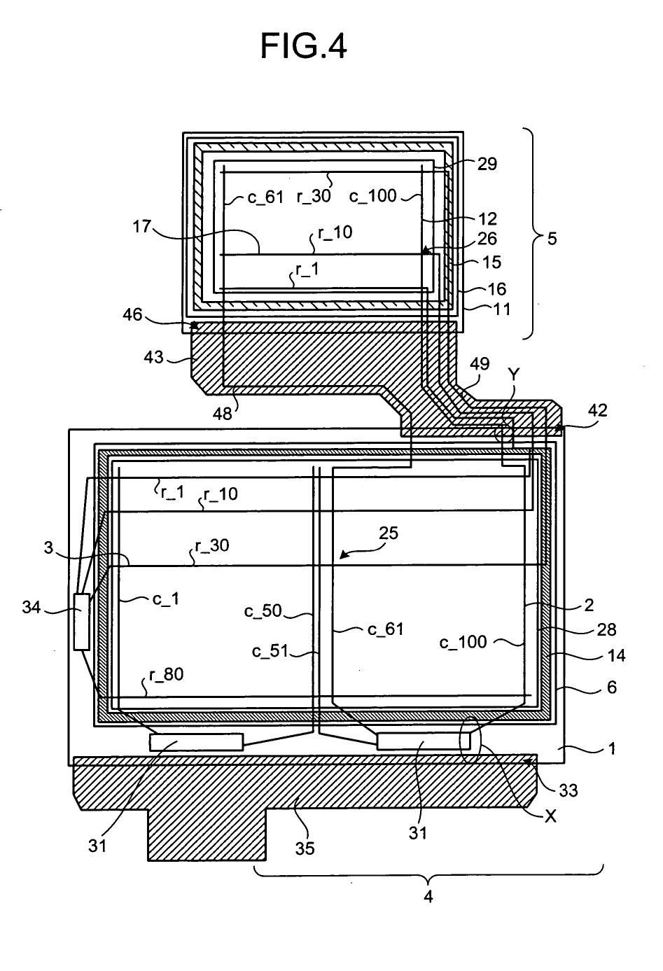

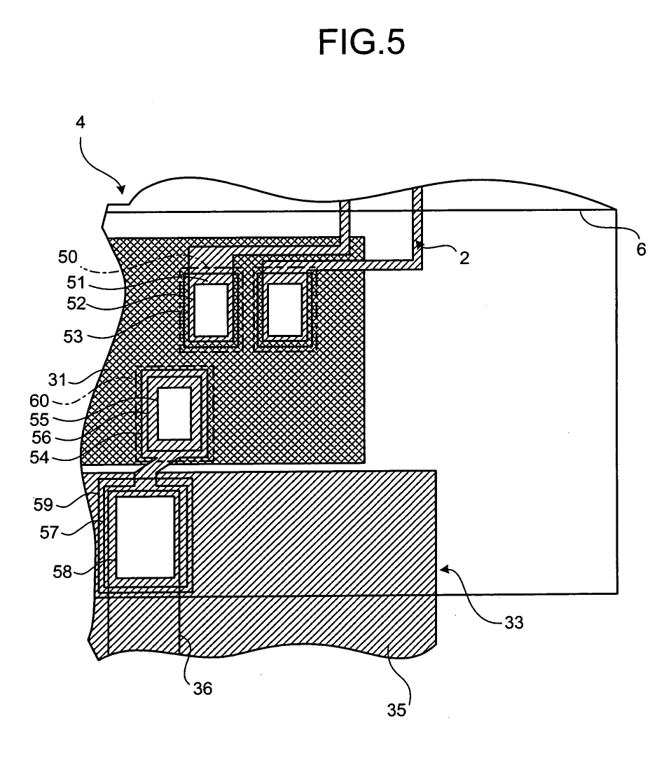

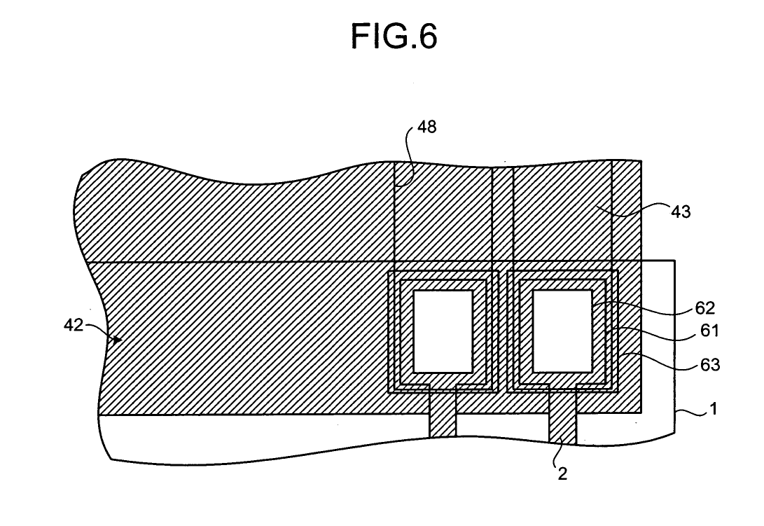

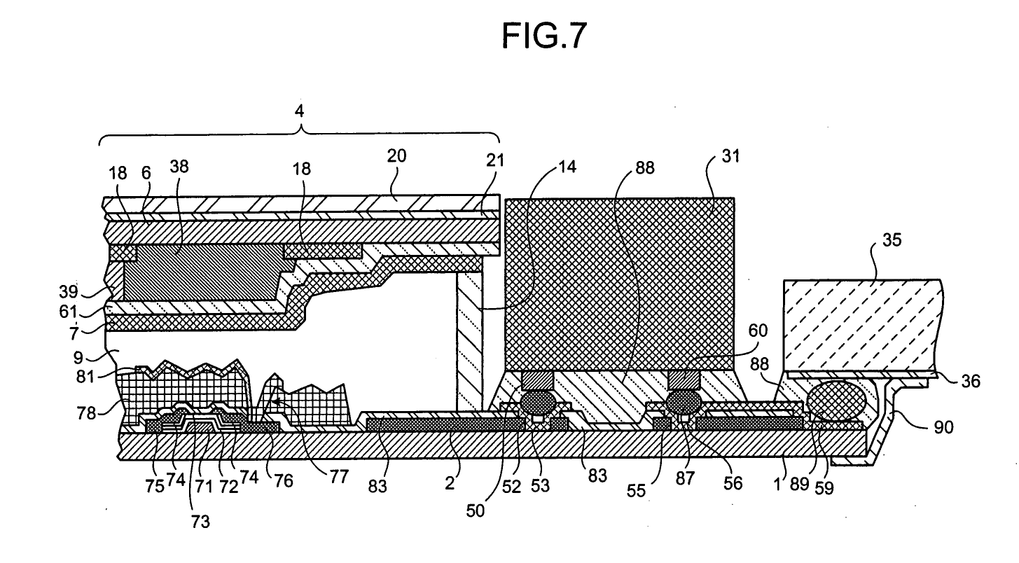

A best mode of a display apparatus for carrying out the present invention is explained below with reference to the drawings. A first display panel 4 is a main liquid crystal display panel, a second display panel 5 is a sub liquid crystal display panel, and all electrodes of the second display panel 5 are wired via electrodes of the first display panel 4 disposed opposite with liquid crystal layer in between. The electrode of the second display panel 5 is connected to the electrode of the first display panel with an inter-panel connector provided between the second display panel 5 and the first display panel 4. FIG. 1 is a perspective view of the display apparatus according to a first embodiment of the present invention, with a front cover of the display apparatus opened. FIG. 2 is a perspective view of the display apparatus according to the first embodiment, with the front cover of the display apparatus closed; FIG. 3 is a cross-section of a part of a display panel block cut along a line A-A in FIG. 2, FIG. 4 is a top plan view of the display panels shown in FIG. 3, which are developed in plane, FIG. 5 is an enlarged top plan view of a part of a driving circuit of the first display panel 4, and FIG. 6 is an enlarged top plan view of a part of a connector between the first display panel 4 and the second display panel 5. A portable telephone according to the first embodiment is explained below by alternately using FIG. 1, FIG. 2, FIG. 3, FIG. 4, FIG. 5, FIG. 6, and FIG. 7.

A configuration of the portable telephone is explained below with reference to FIGS. 1 and 2. The portable telephone shown in FIGS. 1 and 2 is a foldable portable telephone as already explained for the conventional example. FIG. 1 is a perspective view of the portable telephone, with the cover of the portable telephone opened from the main unit to set the main liquid crystal display panel (the first display panel 4) to a display state. In FIG. 2, the cover of the portable telephone is closed to make it compact, and the sub liquid crystal display panel (the second display panel 5) is set to a display state, with the main liquid crystal display panel set to non-display.

As shown in FIG. 1, the main unit of the portable telephone has the plural input buttons 104 for inputting numerals or characters, selecting a mode, switching a power source, and scrolling a screen, and the microphone 107. On both sides of the cover of the portable telephone, the first display panel 4 and the second display panel 5 are disposed back to back. The speaker 106 is formed on the side where the first display panel 4 is mounted.

The first display panel 4 displays communication contents, e-mail contents, Internet information, telephone numbers, remaining battery level, a receiving status, and necessary information for the user, as contents displayed on the first display panel 4.

The antenna 103 and the imaging element 108 are provided on the back side of the portable telephone cover 101. When the back side of the portable telephone cover 101 is closed, the second display panel 5 becomes in a display state, and the backlight (not shown) is lit according to needs. The second display panel 5 displays an imaging status of the imaging element 108, e-mail reception information, a receiving status, remaining battery level, and portable telephone information. The display capacity of the second display panel 5 is set smaller than that of the first display panel 4.

FIG. 3 is a cross-section of the configuration of the first display panel 4 and the second display panel 5, the inter-panel connector that electrically connects between the first display panel 4 and the second display panel 5, and a mounting of an FPC to apply a signal to the first display panel 4 from an external circuit. The first display panel 4 and the second display panel 5 are reflection liquid crystal display panels that utilize light from an external environment in which the portable telephone is used, to save power.

As shown in FIG. 7, a gate electrode 71 as a third electrode 3 consisting of a chrome film containing molybdenum is disposed on a first substrate 1, and a gate insulation film 72 including a silicon nitride film is provided on the gate electrode 71. A semiconductor layer 73 including an amorphous silicon (a-Si) film is provided on the gate insulation film 72. A source electrode 75 as a first electrode 2 and a drain electrode 76 both including a chrome film, are provided on the semiconductor layer 73. An impurity dope layer 74 for doping an impurity ion is provided between the source electrode 75 as the first electrode 2, the drain electrode 76, and the semiconductor layer 73. The above configuration forms a thin-film transistor.

A passivation film 83 including a silicon nitride film is provided on the thin-film transistor to prevent element characteristics from being changed. A concavo-convex insulation film 78 having convexity and concavity on the surface is provided on the passivation film 83. A display electrode 81 that functions as a reflection film is formed using an aluminum film on the concavo-convex insulation film 78. In order to electrically connect between the display electrode 81 and the drain electrode 76, a conductive opening 77 is formed on the passivation film 83 and the concavo-convex insulation film 78.

A color filter is provided on a second substrate 6 facing the first substrate 1. The color filter has a red color filter 38, a green color filter 39, and a blue color filter (not shown). A light-shielding black matrix 18 is provided around the color filter. A color filter protection film 61 is provided on the color filter. A second electrode 7 including a transparent conductive film is provided on the color filter protection film 61 to cover a display area including plural display electrodes 81 disposed in a matrix shape.

The first substrate 1 and the second substrate 6 are adhered together with a predetermined gap between them using a first sealing portion 14, and a first liquid crystal layer 9 is filled into this gap. An orientation film (not shown) is provided on the surface facing the first liquid crystal layer 9, to align the first liquid crystal layer 9 in a predetermined direction.

A first retardation film 21 and a first polarizing film 20 are provided on the surface at the opposite side of the first liquid crystal layer 9 of the second substrate 6. One or plural first retardation films 21 can be laminated.

In FIG. 7, a reference numeral 47 denotes a panel input FPC electrode, 85 denotes an IC bump, 87 denotes an IC mounting conductive particle, 88 denotes an FPC mounting polyimide resin, 89 denotes an FPC mounting conductive particle, 90 denotes an FPC reinforcing member, 59 denotes an external input pad electrode, 35 denotes a flexible printed substrate, and 31 denotes a driving circuit.

Representative examples of the first electrode 2 and the third electrode 3 are shown in FIG. 4. In FIG. 4, a reference numeral 25 denotes a first panel pixel unit, and 26 denotes a second panel pixel unit. For the first electrode 2, source electrodes from a first c_1 to a 50-th c_50 are connected to one of the driving circuits 31, and a 51-st c_51 to a 100-th c_100 are connected to the other first driving circuit 31. Source electrodes c_61 to c_100 pass from the display area of the first display panel 4 to the first sealing portion 14, reach the end of one side of the first display panel 4, and are electrically connected to an inter-panel FPC first electrode 48 provided on the inter-panel FPC 43, using an anisotropic conductive film (ACF) of a first inter-panel connector 42. In FIG. 4, source electrodes of c_2 to c_49 and c_62 to c_99 are not shown.

For the third electrode 3, gate electrodes including a first r_1, a tenth r_10, a 30-th r_30, and an 80-th r_80 are shown, and other gate electrodes are not shown. The gate electrodes r_1 to r_80 are connected to a second driving circuit 34. The gate electrodes r_1 to r_30 pass from the display area of the first display panel 4 to the first sealing portion 14, reach the end of one side of the first display panel 4, and are electrically connected to an inter-panel FPC second electrode 49 provided on the inter-panel FPC 43, using the ACF of the first inter-panel connector 42.

The first driving circuit 31 and the second driving circuit 34 provided on the first substrate 1 are connected to an external circuit (not shown) via the flexible printed substrate 35 provided on the first substrate, thereby inputting a predetermined signal and a power source. A reference numeral 33 denotes a driving circuit connector.

A thin-film transistor is provided on a third substrate 11, like the thin-film transistor provided on the first substrate 1. A color filter and a fourth electrode 17 as a counter electrode, are provided on a fourth substrate 16, like those provided on the second substrate 6. The third substrate 11 and the fourth substrate 16 constitute the second display panel 5. On the second display panel 5, r_1 of the first display panel 4 and r_1 of the second display panel 5 are electrically connected, using the electrode provided on the inter-panel FPC 43 and a second inter-panel connector 46. Similarly, corresponding gate electrodes are electrically connected, like r_10 and r_10, and r_30 and r_30. Also, corresponding source electrodes are electrically connected, like c_61 of the first display panel 4 and c_61 of the second display panel 5, and c_100 and c_100.

According to the present embodiment, the configuration of the inter-panel connector that electrically connects between the first display panel 4 and the second display panel 5 also has characteristics, which are explained with reference to FIGS. 5 and 6. FIG. 5 is an enlarged top plan view of a part X shown in FIG. 4, and FIG. 6 is an enlarged top plan view of a part Y shown in FIG. 4. As shown in FIG. 5, at the part X, the first electrode 2 as the source electrode provided on the first substrate 1 is connected to a first output pad wiring electrode 51, a first output pad insulation film contact hole 52 is provided through the gate insulation film and the passivation film, and a first output pad electrode 53 is formed using an indium tin oxide(ITO) film, superimposed on and electrically connected to a part of the first output pad wiring electrode 51.

The first output pad electrode 53 is electrically connected to a bump electrode 50 that is provided on the first driving circuit 31, and applies a signal from the first driving circuit 31 to the first electrode 2.

A first input IC pad wiring electrode 54 and an external input pad wiring electrode 57 formed with the same material as that of the source electrode are provided on the first substrate 1. The first input IC pad wiring electrode 54 and the external input pad wiring electrode 57 are electrically connected. On the first input IC pad wiring electrode 54, a first input IC pad insulation film contact hole 55 is provided through the gate insulation film and passivation film, and a first input IC pad electrode 56 is formed using an ITO film, superimposed on and electrically connected to a part of the first input IC pad wiring electrode 54.

The first input IC pad electrode 56 is electrically connected to a bump electrode 60 provided on the first driving circuit 31, thereby supplying various signals from an external circuit (not shown) to the first driving circuit 31, applying a power source voltage, and connecting a booster capacitor to the first driving circuit 31.

On the external input pad wiring electrode 57, a first external input pad insulation film contact hole 58 is provided through the gate insulation film and the passivation film, and a first external input pad electrode 59 is formed using an ITO film, superimposed on and electrically connected to a part of the external input pad wiring electrode 57.

The first external input pad electrode 59 is connected to the FPC input electrode 36 on the flexible printed substrate 35, thereby supplying various signals from an external circuit (not shown) to the first driving circuit 31, applying a power source voltage, and connecting a booster capacitor to the first driving circuit 31.

As shown in FIG. 6, the part of Y constitutes a pad electrode that applies a signal to the second display panel 5. The first electrode 2 as the source electrode provided on the first substrate 1 is connected to a first inter-panel pad wiring electrode 61, a first inter-panel pad insulation film contact hole 62 is provided through the gate insulation film and the passivation film, and a first inter-panel pad electrode 63 is formed using an ITO film, superimposed on and electrically connected to a part of the first inter-panel pad wiring electrode 61.

The first inter-panel pad electrode 63 is electrically connected to the inter-panel FPC first electrode 48 provided on the inter-panel FPC 43, thereby applying a predetermined signal to the second display panel 5, and displaying on the second display panel 5.

While not shown in FIG. 5, a signal is also applied to the second driving circuit board 34 from the flexible printed substrate 35, a part of the third electrode 3 as the gate electrode is extended to the inter-panel FPC 43, and a gate electrode signal is applied to the second display panel 5 via the inter-panel FPC 43.

As is clear from the above explanation, the source electrode as the first electrode and the gate electrode as the third electrode provided on the first substrate are extended from the driving circuit to the inter-panel connector of the first display panel 4, and the inter-panel pad electrode is provided on the inter-panel connector. The first electrode and the second electrode are connected to the pad electrode of the inter-panel connector of the second display panel 5, using the inter-panel FPC, and are connected to the source electrode and the gate electrode respectively that constitute the second display panel 5.

In other words, the first electrode in a y-axis direction that constitutes the first display panel 4 is connected to the fourth electrode in a y-axis of the second display panel 5. The third electrode in an x-axis direction is connected to the sixth electrode in an x-axis direction of the second display panel 5. Therefore, a part of the first display panel 4 is displayed on the second display panel 5 when the whole screen of the first display panel 4 is displayed. However, because the display directions are the same, characters are not rotated by 90 degrees or are not inverted by 180 degrees. As a result, the character display can be recognized.

When the second display panel 5 is displayed, one of the two first driving circuits 31 can be set non-driven. Therefore, power consumption can be reduced, which is remarkably effective for the portable telephone. The state of opening and closing the portable telephone cover 101 from the portable telephone main unit 102 of the portable telephone 100 can be easily recognized, based on provision of a hinge 105 or a push button between the portable telephone main unit 102 and the portable telephone cover 101. When the portable telephone cover 101 is closed, power consumption can be reduced by driving the driving circuit that is connected to the first electrode and the second electrode corresponding to the second display area. At the same time, power consumption can be reduced by driving only a circuit block of the pad electrode connected to the first electrode and the second electrode within the driving circuit.

According to the present embodiment, two first driving circuits are provided on the first display panel 4; one of the first driving circuits drives the second display panel 5, and the other first driving circuit stops when driving the second display panel 5, thereby reducing power consumption. Therefore, by providing plural first driving circuits having different number of pad electrodes that supply a driving signal, part of first driving circuits can correspond to the second display panel 5.

For example, when 150 electrodes are provided on the first display panel 4 and when 90 electrodes are provided on the second display panel 5, one of the first driving circuits has 90 output pad electrodes and the other first driving circuit has 60 output pad electrodes.

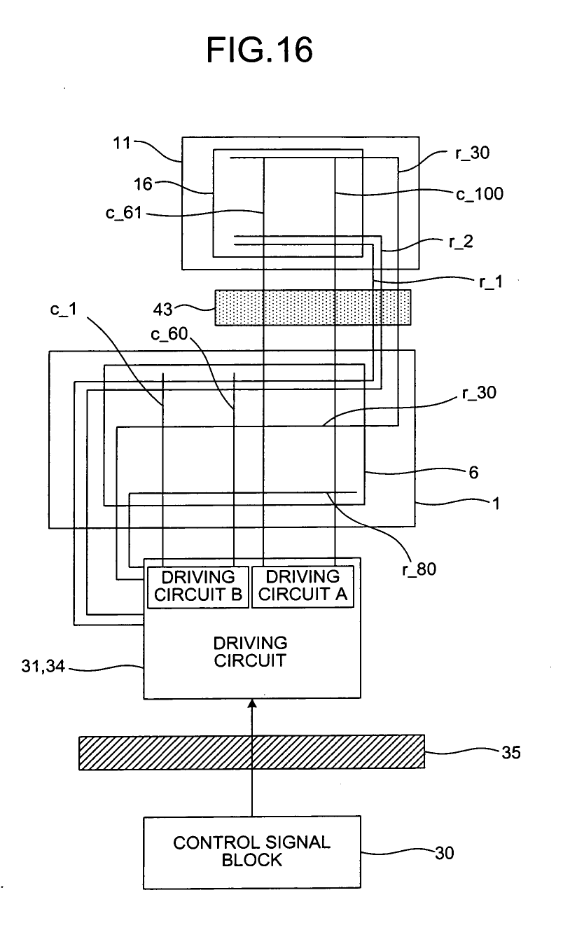

This configuration is explained in detail. As shown in FIG. 16, the source electrodes of the first c_1 to the 60-th c_60 as the first electrode are connected to one first driving circuit 31 (a driving circuit B), and the 61-st c_61 to the 100-th c_100 are connected to the other first driving circuit 31 (a driving circuit A). Based on this configuration, when the driving circuit A of the first driving circuit 31 drives the second display panel 5, the driving circuit B can be stopped, thereby reducing power consumption.

In FIG. 16, only a simplified configuration of the main parts is shown to avoid complexity of the diagram. The first driving circuit 31 and the second driving circuit 34 are collectively shown as the driving circuit. In FIG. 16, while the first and the second driving circuits 31 and 34 are shown in isolation from the substrate 1, the first and the second driving circuits 31 and 34 are actually provided on the first substrate 1.

Based on the above configuration, the number of driving circuits, a mounting area, and power consumption can be reduced respectively, and the cost of the display apparatus can be reduced.

### Second Embodiment

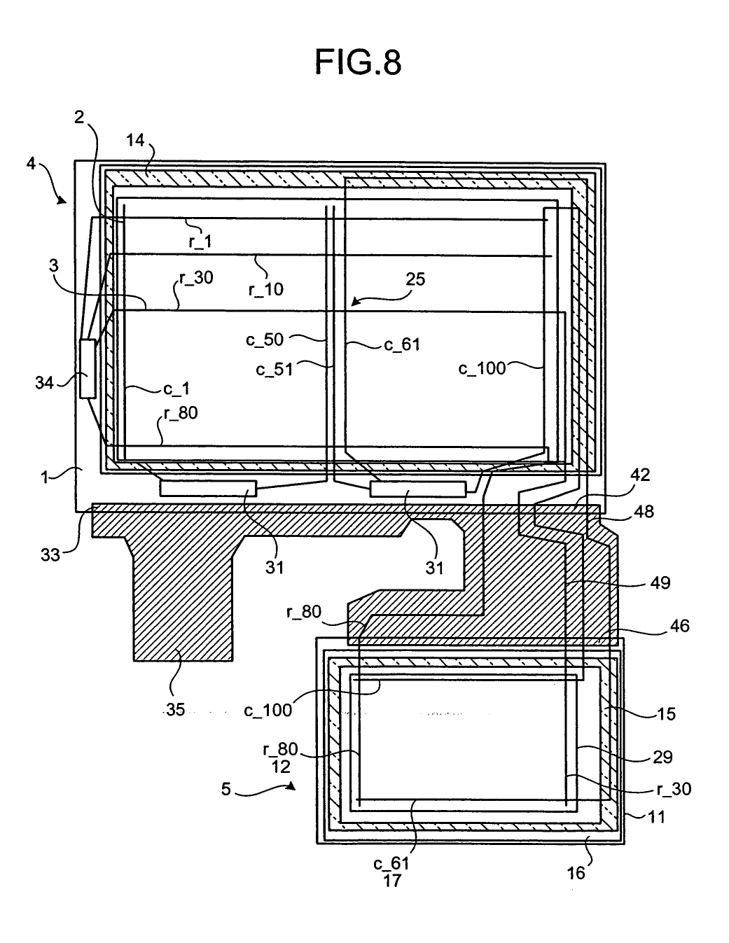

A display apparatus according to a second embodiment of the present invention is explained next with reference to the drawings. According to the second embodiment, a flexible printed substrate that applies an external signal to the driving circuit mounted on the first display panel 4, and an inter-panel connector provided between the first display panel 4 and the second display panel 5, are formed as an integrated flexible printed substrate. FIG. 8 is a top plan view of the first display panel 4 and the second display panel 5 that are developed in plane. The display apparatus according to the second embodiment is explained below with reference to FIG. 8. Like contents and names that are the same as those in the first embodiment are designated with like reference numerals and signs, and their explanations are omitted or simplified.

FIG. 8 is a top plan view of the display apparatus according to another embodiment of that shown in FIG. 4 according to the first embodiment. According to the second embodiment, the first display panel 4 and the second display panel 5 employ an active matrix liquid crystal display panel having a switching element in each pixel unit.

In FIG. 8, representative examples of the first electrode 2 and the third electrode 3 are shown. The source electrodes from the first c_1 to the 50-th c_50 as the first electrode 2 are connected to one first driving circuit 31; and the 51-st c_51 to the 100-th c_100 are connected to the other first driving circuit 31. The source electrodes of c_61 to c_100 pass from the display area of the first display panel 4 to the first sealing portion 14, and reach the end of one side of the first display panel 4, and are electrically connected to the inter-panel FPC first electrode 48 provided on the inter-panel FPC, using the ACF of the first inter-panel connector 42. In FIG. 8, source electrodes of c_2 to c_49 and c_62 to c_99 are not shown.

For the third electrode 3, gate electrodes including the first r_1, the tenth r_10, the 30-th r_30, and the 80-th r_80 are shown. Other gate electrodes are not shown. The gate electrodes r_1 to r_80 are connected to the second driving circuit 34. The gate electrodes r_30 to r_80 pass from the display area of the first display panel 4 to the first sealing portion 14, reach the end of one side of the first display panel 4, and are electrically connected to the inter-panel FPC second electrode 49 provided on the inter-panel FPC, using the ACF of the first inter-panel connector 42.

The first driving circuit 31 and the second driving circuit 34 provided on the first substrate 1 are connected to the external circuit (not shown) via the flexible printed substrate 35 provided on the first substrate, thereby inputting a predetermined signal and a power source.

A thin-film transistor is provided on the third substrate 11. A color filter and the fourth electrode 17 as a counter electrode, are provided on the fourth substrate 16. The third substrate 11 and the fourth substrate 16 constitute the second display panel 5. The electrodes of the first display panel 4 and those of the second display panel 5 are electrically connected, using the electrode provided on the inter-panel FPC and the second inter-panel connector. That is to say, corresponding gate electrodes are electrically connected, like r_30 and r_30, and r_80 and r_80. Also, corresponding source electrodes are electrically connected, like c_61 of the first display panel 4 and c_61 of the second display panel 5, and c_100 and c_100.

According to the present embodiment, the configuration of the inter-panel connector that electrically connects between the first display panel 4 and the second display panel 5 also has characteristics. A flexible printed substrate on which an FPC input electrode that applies a predetermined signal from the external circuit (not shown) to the first driving circuit 31 and the second driving circuit 34 provided on the first substrate 1 that constitutes the first display panel 4, and the inter-panel FPC that constitutes the inter-panel connector, are integrated, thereby reducing steps of mounting the FPC. The cost of the FPC can be also reduced.

Further, according to the present embodiment, the direction of the source electrodes of the first display panel 4 and the direction of the source electrodes of the second display panel 5 are set different by 90 degrees. This setting indicates that, depending on the number of source electrodes and the number of gate electrodes that can be displayed by only one of the first driving circuits 31, the relationship between the number of source electrodes of the first display panel 4 and the number of source electrodes of the second display panel 5 can be optimized, and depending on the relationship of gate electrodes, it is possible to optimize disposition in a direction to reduce power consumption, a relationship of FPC wiring area, and a relationship of wiring of the second display panel 5.

This configuration is explained in detail based on the following example. On the first display panel 4, the number of the first electrodes is 100, and IC's (a first driving IC and a second driving IC) having 50 outputs are used. The number of the second electrodes is 80, and one IC is used. In this example, the first display panel 4 has a laterally long display. To stop one first driving IC, the number of electrodes on one side of the second display panel 5 becomes 50. Therefore, a proper number of electrodes of the second display panel 5 is 50×40. To carry out a vertically long display on the second display panel 5, it is preferable to dispose 50 electrodes in a vertical direction and dispose 40 electrodes in a lateral direction. To carry out a graphical display, it is preferable that pixels are arranged in substantially a square shape.

As explained above, depending on the number of electrodes of the second display panel 2, the lateral-direction wiring of the first display panel 4 can be effectively connected to the vertical-direction wiring of the second display panel 5. For this purpose, the scanning direction is from top to bottom on the first display panel 4, and the scanning direction is from left to right on the second display panel 5. A person who observes the display cannot recognize the scan from top to bottom and the scan from left to right, when the scan frequency is about 30 hertz. Similarly, depending on the number of electrodes of the second display panel 5, the allocation of the wiring of the first display panel 4 in the lateral direction and the vertical direction can be determined by taking into account power consumption and the area of the FPC necessary for the wiring.

### Third Embodiment

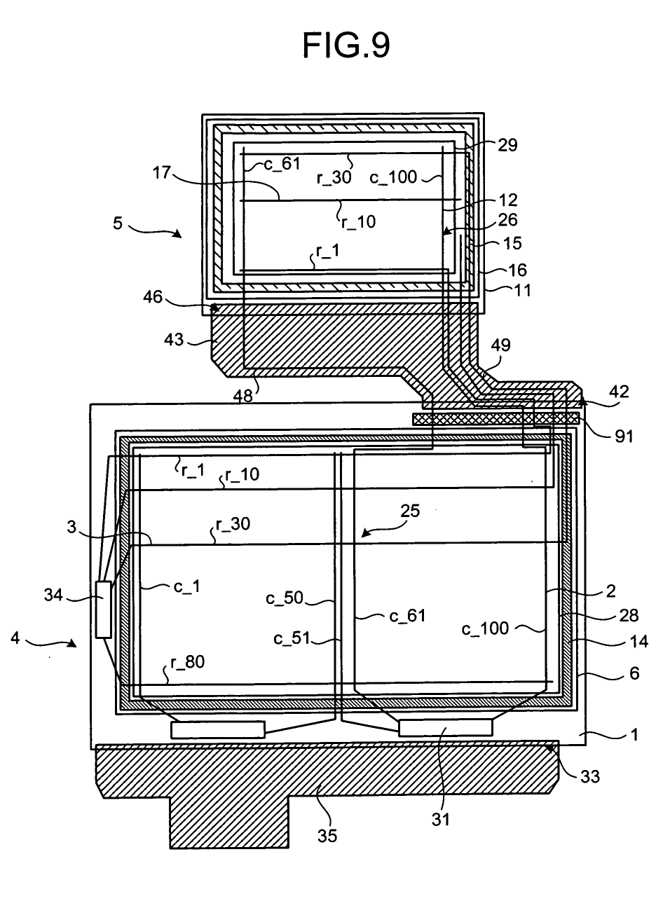

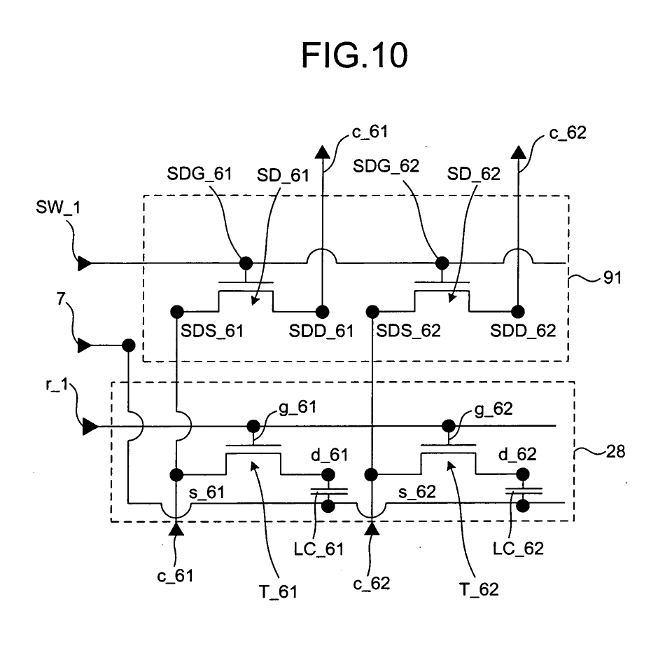

A display apparatus according to a third embodiment of the present invention is explained with reference to the drawings. According to the third embodiment, an inter-panel switching element 91 that controls on/off of the signal to be applied to the second display panel 5 is provided near the inter-panel connector on the first display panel 4. FIG. 9 is a top plan view of the first display panel 4 and the second display panel 5, both of which are developed in plane. FIG. 10 is an equivalent circuit diagram of a part of a pixel unit of the first display panel 4 and a part of the inter-panel switching element. The display apparatus according to the third embodiment is explained below with reference to FIGS. 9 and 10. Like contents and names that are the same as those in the first embodiment are designated with like reference numerals and signs, and their explanations are omitted or simplified.

FIG. 9 is a top plan view of the display apparatus according to another embodiment of that shown in FIG. 4 according to the first embodiment. According to the third embodiment, the first display panel 4 and the second display panel 5 employ an active matrix liquid crystal display panel having a switching element in each pixel unit.

In FIG. 9, representative examples of the first electrode 2 and the third electrode 3 are shown. The source electrodes including the first c_1 to the 50-th c_50 as the first electrode 2 are connected to one first driving circuit 31; and the 51-st c_51 to the 100-th c_100 are connected to the other first driving circuit 31. The source electrodes of c_61 to c_100 pass from the display area of the first display panel 4 to the first sealing portion 14, and reach the end of one side of the first display panel 4, connected to the inter-panel switching element 91 that can select whether to apply a signal to the source electrode of the second display panel 5, and are electrically connected to the inter-panel FPC first electrode 48 provided on the inter-panel FPC 43, using the ACF of the first inter-panel connector 42. In FIG. 9, source electrodes of c_2 to c_49 and c_62 to c_99 are not shown.

For the third electrode 3, gate electrodes including the first r_1, the tenth r_10, the 30-th r_30, and the 80-th r_80 are shown. Other gate electrodes are not shown. The gate electrodes r_1 to r_80 are connected to the second driving circuit 34. The gate electrodes r_1 to r_30 pass from the display area of the first display panel 4 to the first sealing portion 14, reach the end of one side of the first display panel 4, connected to the inter-panel switching element 91 that can select whether to apply a signal to the gate electrode of the second display panel 5, and are further electrically connected to the inter-panel FPC second electrode 49 provided on the inter-panel FPC 43, using the ACF of the first inter-panel connector 42.

The first driving circuit 31 and the second driving circuit 34 provided on the first substrate 1 are connected to the external circuit (not shown) via the flexible printed substrate 35 provided on the first substrate, thereby inputting a predetermined signal and a power source.

A thin-film transistor is provided on the third substrate 11. The color filter and the fourth electrode 17 as a counter electrode, are provided on the fourth substrate 16. The third substrate 11 and the fourth substrate 16 constitute the second display panel 5. On the second display panel 5, r_1 of the first display panel 4 and r_1 of the second display panel are electrically connected, using the electrode provided on the inter-panel FPC 43 and the second inter-panel connector 46. Similarly, corresponding gate electrodes are electrically connected, like r_10 and r_10, and r_30 and r_30. Also, corresponding source electrodes are electrically connected, like c_61 of the first display panel 4 and c_61 of the second display panel 5, and c_100 and c_100.

According to the present embodiment, the inter-panel switching element 91 is formed at a step of forming a switching element (a thin-film transistor) provided on each pixel unit, on the first substrate 1. The configuration of the inter-panel switching element 91 and the switching element of each pixel unit is explained with reference to the equivalent circuit diagram shown in FIG. 10.

In FIG. 10, an area where a display area 28 of the first display panel 4 and the inter-panel switching element 91 are formed is shown. The source electrodes c_61 and c_62 and the gate electrode r_1 are shown as a representative, in the display area 28 of the first display panel 4. The source electrode c_61 has a liquid crystal pixel LC_61. A thin-film transistor T_61 is present between LC_61 and the source electrode c_61. T_61 has a source electrode s_61 and a drain electrode d_61, and has a gate electrode g_61 as a switching control terminal. The gate electrode g_61 is connected to r_1 as the third electrode 3.

A source electrode c_62 has a liquid crystal pixel LC_62. A thin-film transistor T_62 is present between LC_62 and the source electrode c_62. T_62 has a source electrode s_62 and a drain electrode d_62, and has a gate electrode g_62 as a switching control terminal. The gate electrode g_62 is connected to r_1 as the third electrode 3. The other side of the liquid crystal pixel is connected to the second electrode 7.

The source electrode c_61 is connected to SDS_61 corresponding to the source electrode of a thin-film transistor SD_61 provided in the inter-panel switching element 91 provided on the external periphery of the display area. The thin-film transistor SD_61 is provided in the inter-panel switching element 91 and includes the source electrode c_61, SDD_61 that is connected to c_61 of the second display panel 5, and a gate electrode SDG_61.

Similarly, the source electrode c_62 is connected to SDS_62 corresponding to the source electrode of a thin-film transistor SD_62 provided in the inter-panel switching element 91 provided on the external periphery of the display area. The thin-film transistor SD_62 is provided in the inter-panel switching element 91 and includes the source electrode c_61, SDD_62 that is connected to c_62 of the second display panel 5, and a gate electrode SDG_62.

The gate electrode of the thin-film transistor provided in the inter-panel switching element represented by the gate electrodes SDG_61 and SDG_62 is connected to an inter-panel switching element control wiring SW_1 that controls whether to transmit a signal of the first display panel 4 to the second display panel 5.

In the above configuration, it is explained that the source electrode as the first electrode 2 that constitutes the first display panel 4. This similarly applies to the gate electrode as the third electrode 3 that constitutes the first display panel 4. The gate electrode as the third electrode 3 is connected to the source electrode of the thin-film transistor that constitutes the inter-panel switching element 91. The gate electrode of the thin-film transistor that constitutes the inter-panel switching element 91 is connected to the inter-panel switching element control wiring SW_1.

By employing the inter-panel switching element having the above configuration, it is possible to control whether to transmit a signal to the second display panel 5, by using only the inter-panel switching element control wiring SW_1. The thin-film transistor of the inter-panel switching element can be also formed simultaneously with the formation of the thin-film transistor that constitutes the first display panel 4. Therefore, there is no manufacturing load of forming the inter-panel switching element.

The inter-panel switching element can be provided around the display area of the first display panel 4, and the thin-film transistor wiring can be formed, thereby increasing integration. Therefore, the area of forming the inter-panel switching element 91 can be made very small.

When the display of the second display panel 5 is not necessary, the thin-film transistor of the inter-panel switching element is turned off to consume little power, thereby setting power consumption of the second display panel 5 to zero, which is remarkably effective for the portable telephone.

### Fourth Embodiment

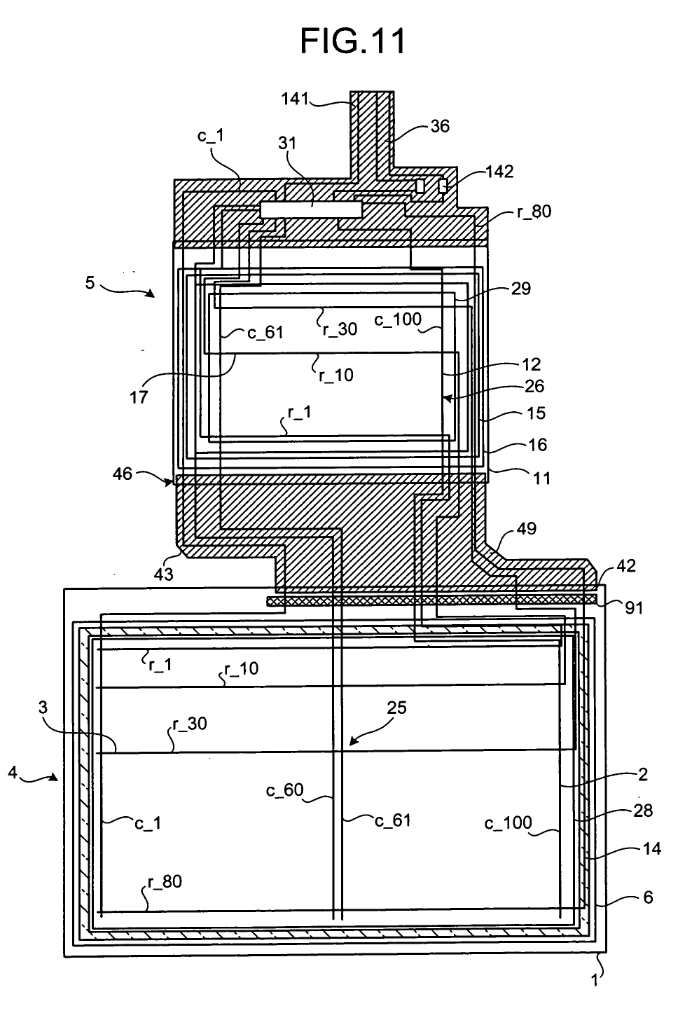

A display apparatus according to a fourth embodiment of the present invention is explained with reference to the drawings. According to the fourth embodiment, a driving circuit is provided on the second display panel 5, and an inter-panel switching element is provided on the first display panel 4. By providing the driving circuit on the second display panel 5, and providing the inter-panel switching element, very low power consumption becomes possible. FIG. 11 is a top plan view of the first display panel 4 and the second display panel 5, both of which are developed in plane. The display apparatus according the fourth embodiment is explained below with reference to FIG. 11. Like contents and names that are the same as those in the third embodiment are designated with like reference numerals and signs, and their explanations are omitted or simplified.

FIG. 11 is a top plan view of the display apparatus according to another embodiment of that shown in FIG. 4 according to the first embodiment. According to the fourth embodiment, the first display panel 4 and the second display panel 5 employ an active matrix liquid crystal display panel having a switching element in each pixel unit.

A configuration of the second display panel 5 according to the fourth embodiment is explained. A display area of the second display panel 5 consists of 40 source electrodes from c_61 to c_100 as a fourth electrode 12, and 30 gate electrodes from r_1 to r_30 as a sixth electrode.

The source electrodes c_1 to c_60 bound to be the first electrode 2 constituting the display area of the first display panel 4 are electrically connected to the source electrodes on the first display panel 4 via the external periphery of the display area of the second display panel 5, the second inter-panel connector 46, the inter-panel FPC 43, and the first inter-panel connector 42. The source electrodes c_1 to c_60 are further connected to the source electrodes of the thin-film transistor constituting the inter-panel switching element 91 on the first substrate 1, thereby forming the source electrodes in the display area of the first display panel 4.

The source electrodes c_61 to c_100 are electrically connected to the source electrodes of the display area of the second display panel 5. The source electrodes c_61 to c_100 are further connected, via the second inter-panel connector 46, the inter-panel FPC 43, and the first inter-panel connector 42, to the source electrodes of the thin-film transistor constituting the inter-panel switching element 91 on the first substrate 1, thereby forming the source electrodes in the display area of the first display panel 4.

In other words, the source electrodes provided on the display area of the first display panel 4 include two kinds of source electrodes, that is, the source electrodes that are connected to the electrodes on the external periphery of the second display panel 5, and the source electrodes provided in the display area of the second display panel 5. All source electrodes are connected via the inter-panel switching element 91 provided on the external periphery of the first display panel 4. The source electrodes c_2 to c_49 and c_62 to c_99 are not shown in FIG. 11.

The gate electrodes r_31 (not shown) to r_80 bound to be the third electrode 3 constituting the display area of the first display panel 4 are electrically connected to the source electrodes of the thin-film transistor constituting the inter-panel switching element 91 on the first display panel 4, via the external periphery of the display area of the second display panel 5, the second inter-panel connector 46, the inter-panel FPC 43, and the first inter-panel connector 42, thereby forming the gate electrodes in the display area of the first display panel 4.

The gate electrodes r_1 to r_30 are electrically connected to the gate electrodes of the display area of the second display panel 5. The gate electrodes r_1 to r_30 are further connected, via the second inter-panel connector 46, the inter-panel FPC 43, and the first inter-panel connector 42, to the source electrodes of the thin-film transistor constituting the inter-panel switching element 91 on the first display panel 4, thereby forming the gate electrodes in the display area of the first display panel 4.

In other words, the gate electrodes provided on the display area of the first display panel 4 include two kinds of gate electrodes, that is, the gate electrodes of the first display panel 4 that are connected to the gate electrodes on the external periphery of the second display panel 5, and the gate electrodes provided in the display area of the second display panel 5. All gate electrodes are connected via the inter-panel switching element 91 provided on the external periphery of the first display panel 4. The gate electrodes r_2 to r_9, r_11 to r_29, and r_31 to r_79 are not shown in FIG. 11.

When the above configuration is employed, based on the inter-panel switching element 91 provided on the first display panel 4, the display of the first display panel 4 can be turned on or off with very low power consumption. When the display of the first display panel 4 is not necessary, the display of the first display panel 4 can be set to off, thereby greatly reducing the power consumption.

A chip on film (COF) 141 for mounting the driving circuit 31 on the flexible printed substrate is connected to the second display panel 5. By employing the COF mounting, the number of display pixels on the first display panel 4 is increased as compared with the number of display pixels on the second display panel 5. Therefore, the wiring from the driving circuit can be achieved on the COF 141. As a result, the external shape of the third substrate 11 to which the COF 141 of the second display panel 5 is connected can be made small. Because the COF 141 can be folded along the external shape of the second substrate 11, the external shape including the COF 141 can be made small, which is effective for the present invention. A chip mounting part 142 such as a booster capacitor of the first driving circuit 31 can be mounted on the COF 141, and therefore, the number of electrodes connected to an external substrate (not shown) can be reduced.

The electrode from the driving circuit 31 can be the electrode of the display area of the first display panel 4, via the COF 141 and the external periphery of the display area, without via the display area of the second display panel 5. Therefore, a group of circuits that control both the second display panel 5 and the first display panel 4 and the group of circuits that control only the first display panel 4 are provided in the driving circuit 31. When driving only the second display panel 4, the group of circuits that control only the first display panel 4 are stopped, and the inter-panel switching element 91 interrupts the signal from the group of circuits that control the display area of the second display panel 5. With this arrangement, power is consumed to display only the second display panel 5.

To display the first display panel 4, both the group of circuits that control the display areas of both the second display panel 5 and the first display panel 4 and the group of circuits that control only the first display panel 4 are driven. Further, the inter-panel switching element 91 is turned on. With this arrangement, all the source electrodes and the gate electrodes that constitute the display area of the first display panel 4 can be driven.

According to the present embodiment, it is explained that the number of the inter-panel switching element control wiring for the thin-film transistor of the inter-panel switching element 91 is one. However, when plural inter-panel switching element control wirings are provided, the display area of the first display panel 4 can be partially displayed, which is effective to reduce power consumption. The present invention includes validity of providing plural inter-panel switching element control wirings for the thin-film transistor of the inter-panel switching element 91.

### Fifth Embodiment

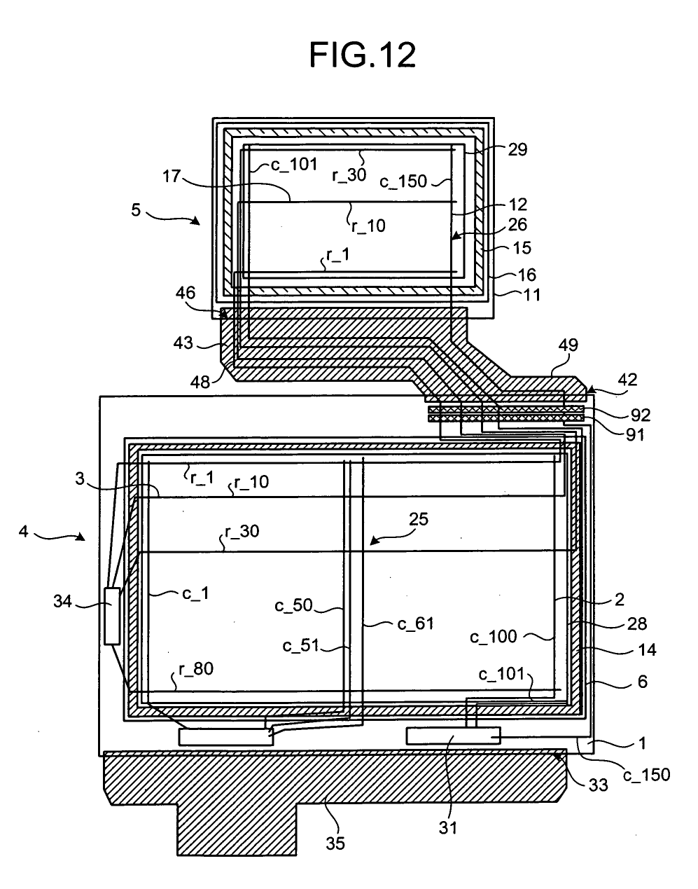

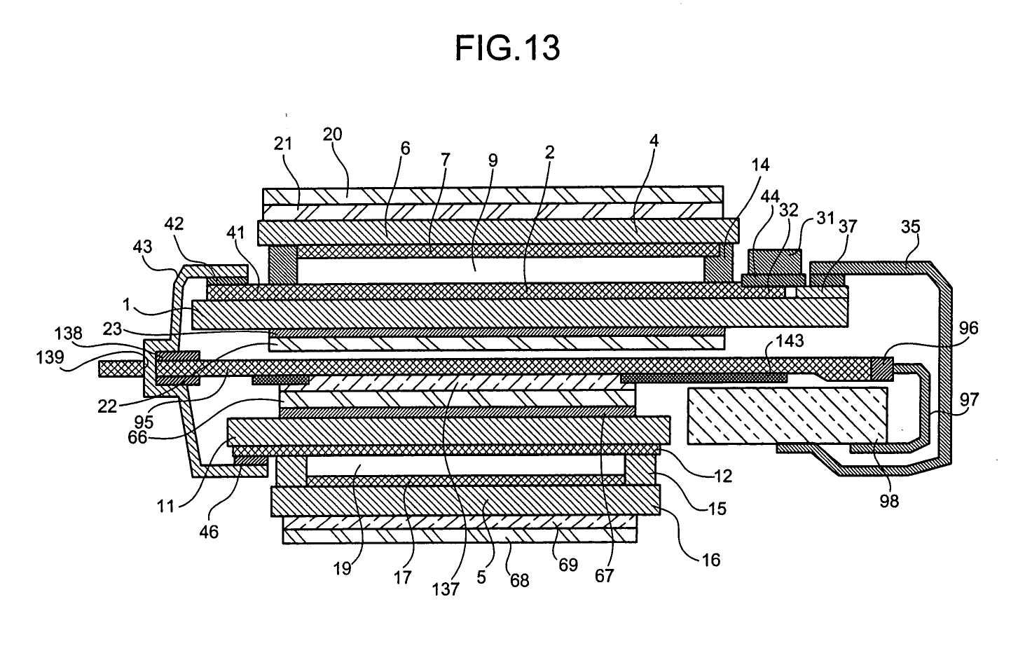

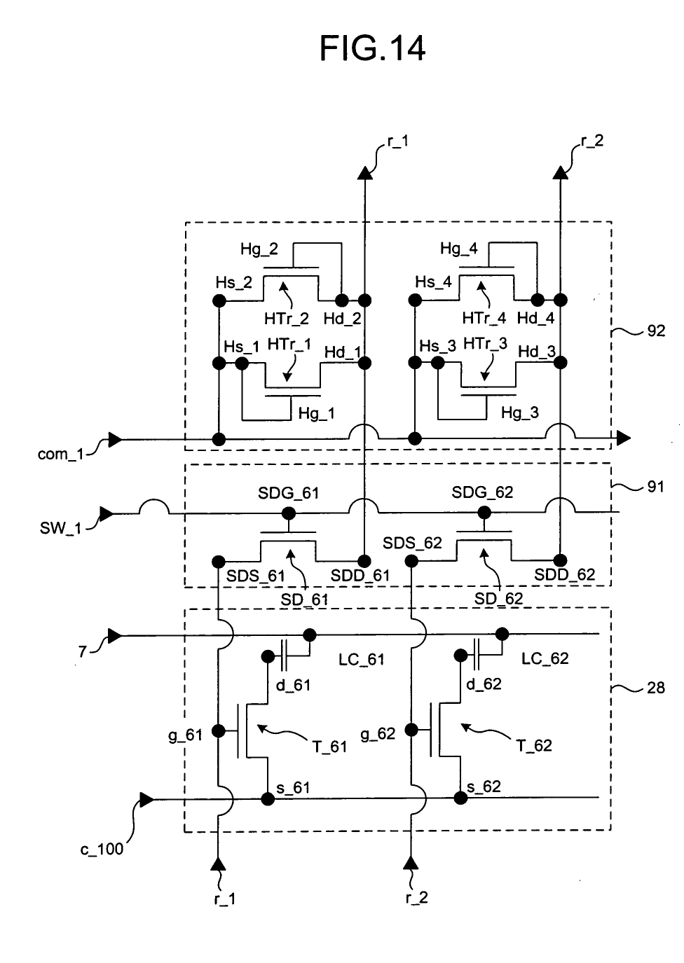

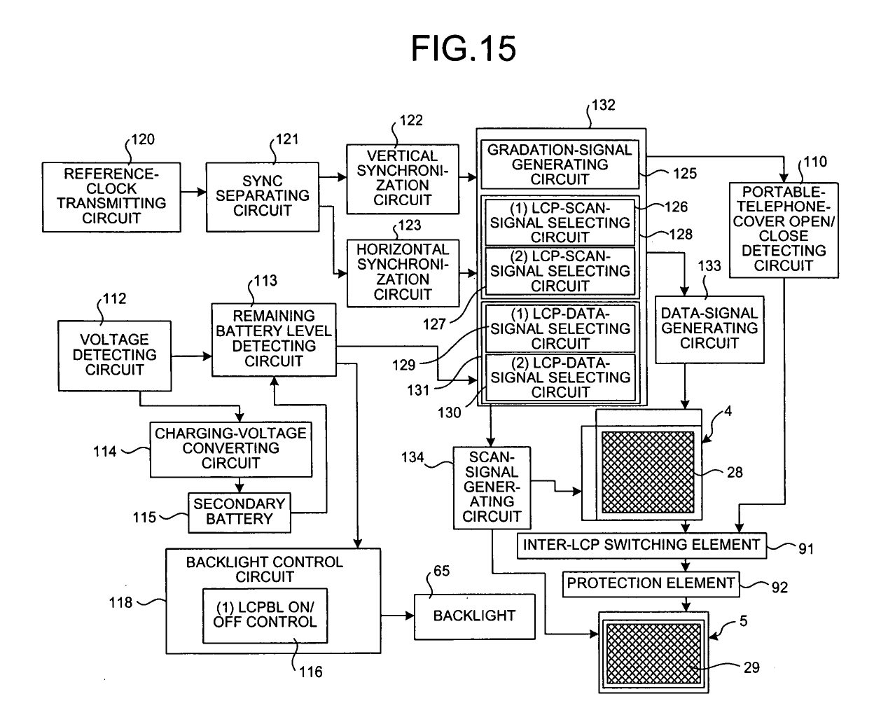

A display apparatus according to a fifth embodiment of the present invention is explained with reference to the drawings. According to the fifth embodiment, the inter-panel switching element 91 that controls turning on and off of a signal to the second display panel 5 is provided near the inter-panel connector on the first display panel 4. Further, a protection element is provided to prevent the inter-panel switching element and the switching element of the display area from being degraded or damaged due to static electricity. FIG. 12 is a top plan view of the first display panel 4 and the second display panel 5, both of which are developed in plane. FIG. 13 is a cross-section of a module that the first display panel 4 and the second display panel 5 are built into a portable telephone, as a main liquid crystal display panel and as a sub liquid crystal display panel, respectively. FIG. 13 corresponds to FIG. 3 according to the first embodiment. FIG. 14 is a block circuit diagram of a configuration of a switching element and a protection element. FIG. 15 is a system block diagram of a portable telephone. The display apparatus according to the fifth embodiment is explained below with reference to FIG. 12, FIG. 13, FIG. 14, and FIG. 15, alternately. Like contents and names that are the same as those in the third embodiment are designated with like reference numerals and signs, and their explanations are omitted or simplified.

FIG. 12 is different from FIG. 9 according to the third embodiment in that the inter-panel switching element 91 and the protection element 92 are provided between the first display panel 4 and the second display panel 5. A part of the first driving circuit 31 provided on the first substrate 1 detours around the external periphery of the display area of the first display panel 4, and reaches the inter-panel switching element 91, and the protection element 92, without via the electrode of the display area.

In FIG. 12, representative examples of the first electrode 2 and the third electrode 3 are shown. The source electrodes including the first c_1 to the 61-st c_61 as the first electrode 2 are connected to one first driving circuit 31, and the 62-nd c_62 (not shown) to the 100-th c_100 are connected to the other first driving circuit 31. Source electrodes c_101 to c_150 of the other first driving circuit 31 detour around the external periphery of the display area 28 of the first display panel 4, and directly reaches the inter-panel switching element 91. In FIG. 12, source electrodes c_2 to c_49, c_52 to c_60, c_62 to c_99, and c_102 to c_149 are omitted.

For the third electrode 3, gate electrodes including the first r_1, the tenth r_10, the 30-th r_30, and the 80-th r_80 are shown. Other gate electrodes are not shown. The gate electrodes r_1 to r_30 are connected to the gate electrodes comprising the sixth electrode of the second display panel 5 via the inter-panel switching element 91 and the protection element 92.

The first driving circuit 31 and the second driving circuit 34 provided on the first substrate 1 are connected to the external circuit (not shown) via the flexible printed substrate 35 provided on the first substrate 1, thereby inputting a predetermined signal and a power source.

A thin-film transistor is provided on the third substrate 11. The color filter and the fourth electrode 17 as a counter electrode, are provided on the fourth substrate 16. The third substrate 11 and the fourth substrate 16 constitute the second display panel 5. On the second display panel 5, r_1 of the first display panel 4 and r_1 of the second display panel are electrically connected, using the electrode provided on the inter-panel FPC 43 and the second inter-panel connector 46. Similarly, corresponding gate electrodes are electrically connected, like r_10 and r 10, and r_30 and r_30. Also, corresponding source electrodes are electrically connected, like c_101 of the first driving circuit 31 and c_101 of the second display panel 5, and c_150 and c_150.

According to the present embodiment, the inter-panel switching element 91 and the protection element 92 are formed at a step of forming a switching element (a thin-film transistor) provided on each pixel unit, on the first substrate 1.

The configuration of the display apparatus that uses the first display panel 4 as a main liquid crystal display panel and uses the second display panel 5 as a sub liquid crystal display panel is explained below with reference to FIG. 13. A transflective liquid crystal display panel is employed for the first display panel 4 and the second display panel 5, to recognize in a dark environment. A backlight unit made of an integrated light guide 95 is provided between the first display panel 4 and the second display panel 5.

The first display panel 4 having the switching element is configured as follows. The first substrate 1 is set on the light guide 95. The first substrate 1 and the second substrate 6 are adhered together with a predetermined gap between them using the first sealing portion 14, and the first liquid crystal layer 9 is filled into this gap. An external circuit connection electrode 37 that connects a signal of a substrate 98 which generates a signal for a display module of a portable telephone to the first driving circuit 31 via the flexible printed substrate 35, and a first inter-panel connection electrode 41 that connects a driving circuit connection electrode 32 and the inter-panel FPC 43 which transmits a signal to the second display panel 5, are provided on the first substrate 1.

A light guide groove 139 that fixes the inter-panel FPC 43 is provided on the light guide 95 that constitutes the backlight unit. A panel photoconductive plate adhering member 138 is provided between the inter-panel FPC 43 and the light guide groove 139, to fix the inter-panel FPC 43 to the light guide groove 139. The inter-panel FPC 43 can be firmly fixed to the light guide with the two kinds of fixing members. The light guide groove 139 is provided on other than the side on which an electroluminescent (EL) element (not shown) is provided.

Light emitted from the light guide 95 to the second display panel 5 and reflected from the second display panel 5 is used to display the first display panel 4. Therefore, a reflection adjusting member 143 having reflectance substantially the same as that of the second display panel 5 is provided around the display area of the second display area 5. The reflection adjusting member 143 is formed using a thin-film metal film having translucency. Based on the provision of the reflection adjusting member 143, amount of light emitted from the light guide 95 to the first display panel 4 can be made uniform. As a result, the display quality of the first display panel 4 can be made uniform.

The third substrate 11 or the fourth substrate 16 that constitutes the second display panel 5 is a thin plate. Therefore, to prevent them from being warped or damaged, one of the substrates 11 and 16 is adhered with a panel-light guide adhering member 137. This is valid to effectively guide the light from the light guide 95 to the second display panel 5. The reflection adjusting member 143 is a thin film. Therefore, the substrate that constitutes the second display panel 5 can be adhered to the reflection adjusting member 143 or the light guide 95, with the panel-light guide adhering member 137.

The first driving circuit 31 is mounted on the external circuit connection electrode 37 and the driving circuit connection electrode 32 according to a chip-on-glass mounting method using an ACF 44. The inter-panel FPC 43 that is connected to the first inter-panel connection electrode 41 or the flexible printed circuit board 35 that is connected to the external circuit electrode 37 are mounted by applying thermal pressure using the ACF.

The first display panel 4 has the first retardation film 21, and the first polarizing film laminated in this order, on the opposite side of the first liquid crystal layer 9 of the second substrate 6. A second retardation film 23 and a second polarizing film 22 are laminated in this order on the opposite side of the first liquid crystal layer 9 of the first substrate 1. A laminated film of plural retardation films can be used for the first retardation film 21 or the second retardation film 23.

A transflective plate of a thin metal film that transmits light is used for a display electrode (not shown) provided on the first substrate 1. Alternatively, with a transparent electroconductive film provided on a light-transmitting opening that is provided on a plate that reflects substantially all light, a transflective plate that selectively functions for a reflection part and a transmission part is used.

The second display panel 5 has the following configuration. The third substrate 11 is provided on the light guide 95. The third substrate 11 is adhered with the fourth substrate 16, with a predetermined gap between the two substrates, using the second sealing member 15, and a second liquid crystal layer 19 is sealed in the gap. The second inter-panel connection electrode 42 that is connected to the inter-panel FPC 43 which transmits a signal from the first display panel 4 to the second display panel 5 is provided on the third substrate 11.

The second inter-panel connection electrode 42 that is connected to the inter-panel FPC 43 is mounted by applying thermal pressure using the ACF via the second inter-panel connector 46.

The second display panel 5 has a third retardation film 67, and a third polarizing film 66 laminated in this order, on the opposite side of the second liquid crystal layer 19 of the third substrate 11. A fourth retardation film 69 and a fourth polarizing film 68 are laminated in this order on the opposite side of the second liquid crystal layer 19 of the fourth substrate 16. A laminated film of plural retardation films can be used for the third retardation film 67 or the fourth retardation film 69.

A transflective plate of a thin metal film that transmits light is used for a display electrode (not shown) provided on the third substrate 11. Alternatively, with a transparent electroconductive film provided on a light-transmitting opening that is provided on a plate that reflects substantially all light, a transflective plate that selectively functions for a reflection part and a transmission part is used.

When the external environment is dark, a light-emitting diode (LED) element 96 that is connected to a substrate 98 via a BL connection member 97 is lit. Light is irradiated to the first display panel 4 and the second display panel 5 via the light guide 95, thereby displaying as a transmissive liquid crystal display panel. When the external environment is bright, display is carried out as a reflection liquid crystal display panel.

The configuration of the inter-panel switching element 91, the protection element 92, and the switching element of each pixel unit is explained next with reference to an equivalent circuit of FIG. 14.

In FIG. 14, the display area 28 of the first display panel 4, and areas in which the inter-panel switching element 91 and the protection element 92 are formed are shown. The display area 28 of the first display panel 4 and the inter-panel switching element 91 are substantially the same as those according to the third embodiment shown in FIG. 10, and their explanation is omitted.

An output r_1 from SDD_61 of the thin-film transistor SD_61 of the inter-panel switching element 91 is connected to two thin-film transistors HTr_1 and HTr_2 in the area of the protection element 92. A source electrode Hs_1 that constitutes the thin-film transistor HTr_1 is connected to Hg_1, to function as a diode. A drain electrode Hd_2 that constitutes the thin-film transistor HTr_2 is connected to Hg_2, to function as a diode. The two thin-film transistors connect between the source electrodes Hs_1 and Hs_2, and between the drain electrodes Hd_1 and Hd_2, thereby configuring a bipolar diode (a diode ring connection).

The bipolar diode source electrode Hs is connected to com_1 that is connected to the second electrode of the first display panel 4 and the fifth electrode 17 of the second display panel 5. The drain electrode Hd is connected to the drain electrode SDD_61 of the thin-film transistor SD_61 that constitutes the inter-panel switching element 91, and is connected to r_1 of the first display panel 4 and r_1 of the second display panel 5. When a voltage higher than the potential of the com_1 electrode is applied to the gate electrode r_1, the thin-film transistor HTr_2 is turned on, and a current flows to com_1, thereby momentarily reducing a potential difference of r_1.

On the other hand, when a voltage lower than the potential of the com_1 electrode is applied to the gate electrode r_1, the thin-film transistor HTr_1 is turned on, and a current flows from com_1, thereby momentarily reducing a potential difference of r_1.

This similarly applies to r_2. The protection element 92 ring connects between the thin-film transistors HTr_3 and THr_4. The effect is similar to that obtained for r_1.

As is clear from the above explanation, based on the provision of the inter-panel switching element 91, when the display of the second display panel 5 is turned off, the inter-panel switching element 91 interrupts the signal of the gate electrode as the third electrode 3, and stops applying a signal to a gate electrode as the sixth electrode 13. To display the second display panel 5, the inter-panel switching element 91 switches on.

As for the connection of the source electrode as the fourth electrode 12 of the second display panel 5, the output of the first driving circuit 31 is directly connected to the inter-panel switching element 91 by detouring around the first display area using the wiring provided on the first substrate 1. Therefore, the first driving circuit 31 can control on and off of the display of the second display panel 5. The inter-panel switching element 91 can also switch between on and off.

Energy saving is achieved in the following order. First, only the inter-panel switching element 91 is switched off. Further, the source electrode of the second display panel 5 of the first driving circuit 31 is turned off. To further save energy, the inter-panel switching element 91 and the source electrode of the second display panel 5 of the first driving circuit 31 are switched off.

Functions of the display apparatus (portable telephone) that has the first display panel 4 and the second display panel 5 according to the present invention is explained below with reference to a system block diagram shown in FIG. 15. In FIG. 15, a system that achieves a target display of the first display panel 4 as a main liquid crystal display panel and a second display panel 5 as a sub liquid crystal display panel is shown.

The present system uses a secondary battery 115 for a power source, has a charging voltage converting circuit 114, a voltage detecting circuit 112, and a remaining battery level detecting circuit 113, applies a signal to a backlight control circuit 118 based on a remaining battery level, and starts an LCPBL on/off control 116. The present system turns on/off a backlight 65 based on an instruction from a backlight control circuit 118.

A synchronization separating circuit 121 carries out synchronization separation of a reference frequency signal of a reference clock transmitting circuit 120, and applies a signal to a vertical synchronization circuit 122 and a horizontal synchronization circuit 123. A signal from the horizontal synchronization circuit 123 is transmitted to a scan signal control block 128. The scan signal control block 128 includes (1) an LCP scan signal selecting circuit 126 that drives the first display panel 4, and (2) and an LCP scan signal selecting circuit 127 that drives the second display panel 5.

A signal from the vertical synchronization circuit 122 is transmitted to a gradation signal generating circuit 125, and is further transmitted to a data signal control block 131. The data signal control block 131 includes (1) an LCP data signal selecting circuit 129 that drives the first display panel 4, and (2) an LCP data signal selecting circuit 130 that drives the second display panel 5.

The scan signal control block 128 outputs a signal to a scan signal generating circuit 134. The data signal control block 131 outputs a signal to a data signal generating circuit 133. Based on signals from the remaining battery level detecting circuit 113 and a portable telephone cover open/close detecting circuit 110, it is determined whether the first display panel 4 is displayed or the second display panel 5 is displayed, it is also determined whether a driving signal is applied to the first display panel 4 or the second display panel 5, and the inter-panel switching element 91 is turned on or off.

The present system also has the protection element 92, and improves display quality of the first display area 28 of the first display panel 4 or a second display area 29 of the second display panel 5. The protection element 92 can also prevent the inter-panel switching element 91 from being changed or degraded, thereby achieving protection of the switching element from static electricity over a larger range than that achieved by the conventional protection element that prevents degradation of a single display panel switching element.

According to the fifth embodiment of the present invention, the protection element 92 is provided between the inter-panel switching element 91 and the second display panel 5. When a protection element is further provided between the first display panel 4 and the inter-panel switching element 91, protection of the inter-panel switching element 91 and improvement in the quality of the display area 28 of the first display panel 4 can be achieved.

According to the fifth embodiment of the present invention, in order to reduce area in which the protection element 92 is provided and to reduce power consumption due to reduction in leak current of the protection element 92, the protection element 92 is provided on only the first substrate 1 that constitutes the first display panel 4. When the protection element 92 is provided on the third substrate 11 that constitutes the second display panel 5, protection against static electricity when the second display panel 5 is processed as a single unit can be achieved, which is effective.

### Sixth Embodiment

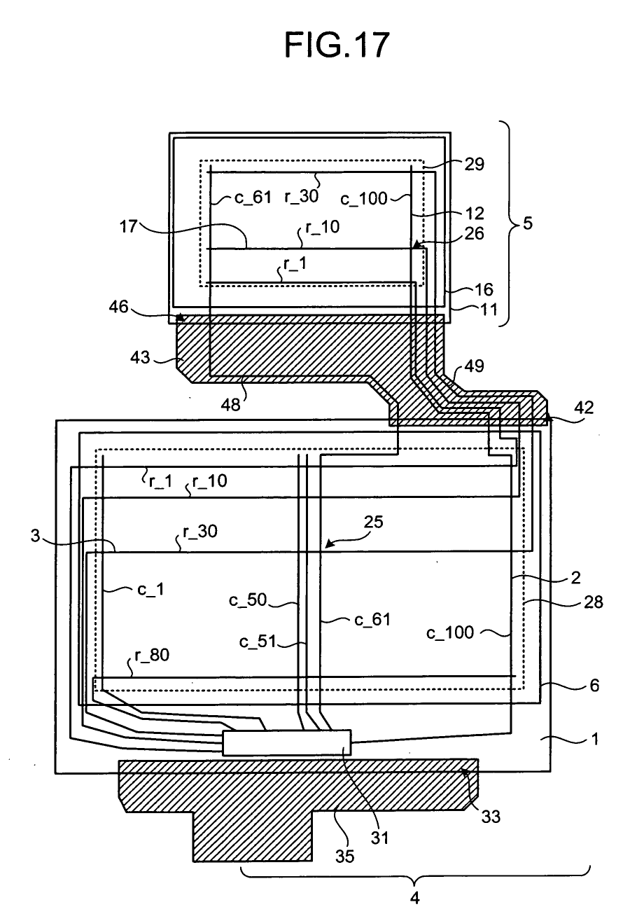

FIG. 17 is a top plan view of a main part of display panels according to a sixth embodiment of the present invention, which is developed in plane. In FIG. 17, sealing portions of the first and the second display panels 4 and 5 are omitted, to avoid complexity of the diagram. Like configurations in the above embodiments are designated with like reference signs, and their explanations are omitted.

The display apparatus according to the sixth embodiment has the following configuration. The source electrodes c_1 to c_100 as the first electrode 2 and the gate electrodes r_1 to r_80 as the third electrode 3 are connected to the same driving circuit 31. The one driving circuit 31 drives the source electrodes and the gate electrodes. According to this configuration, only one integrated circuit is sufficient to configure the driving circuit 31. Therefore, the mounting space of the integrated circuit can be reduced.

### Seventh Embodiment

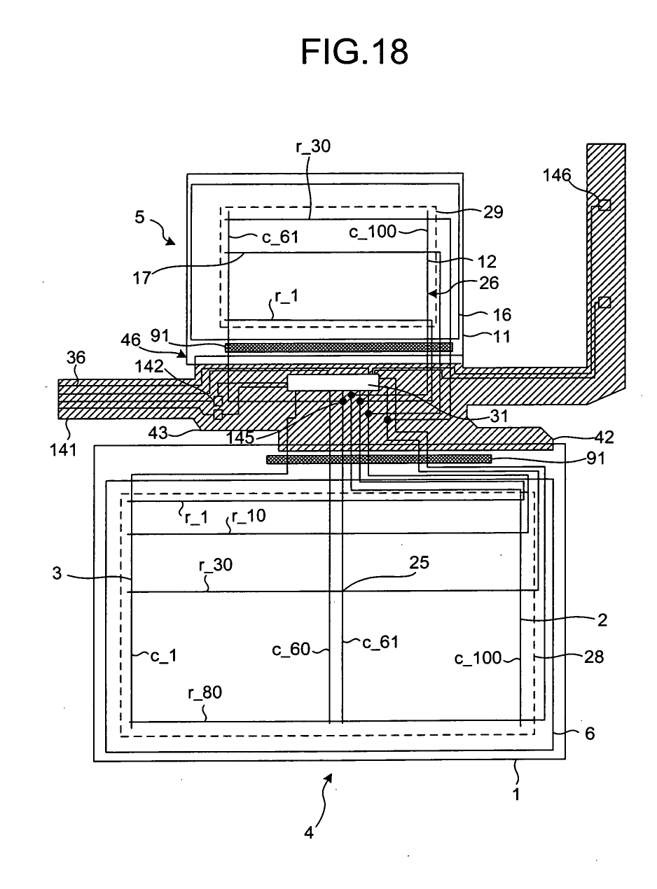

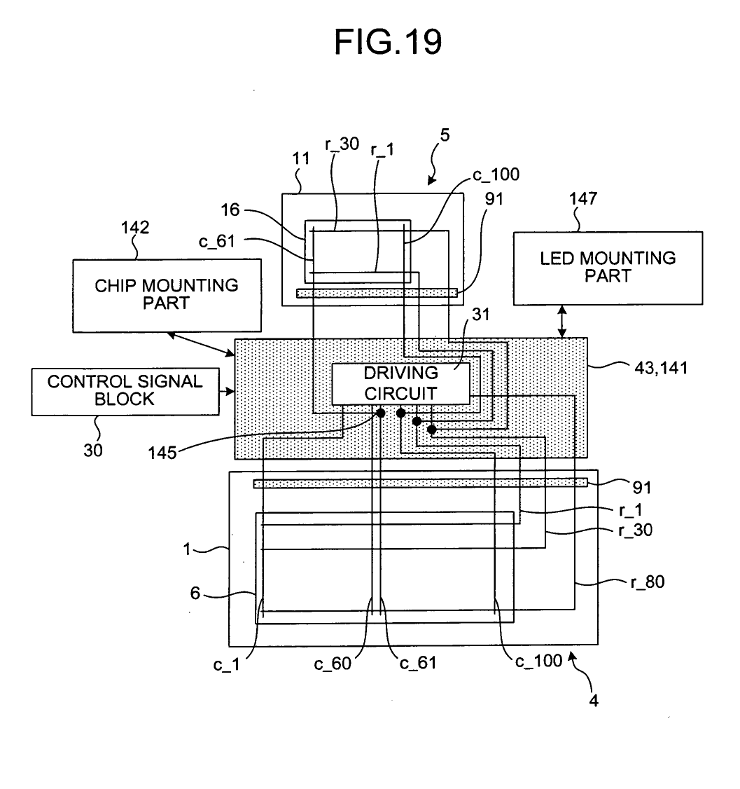

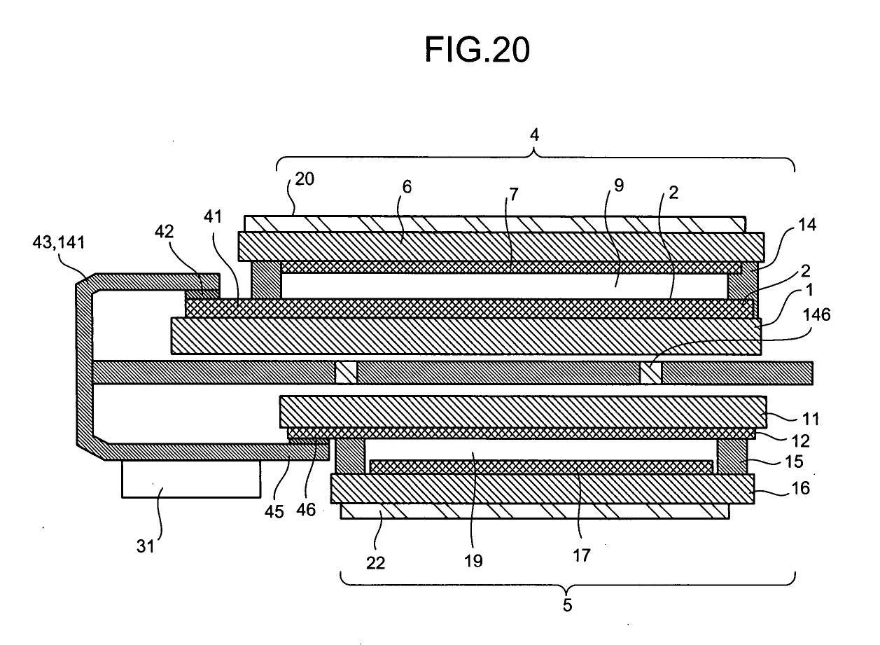

FIG. 18 is a top plan view of a main part of display panels according to a seventh embodiment of the present invention, which are developed in plane. FIG. 19 is a schematic top plan view of the display panels. FIG. 20 is a cross-section of a part of a display panel block cut along a line A-A in FIG. 2, according to the seventh embodiment. In FIG. 18, sealing portions of the first and the second display panels 4 and 5 are omitted, to avoid complexity of the diagram. Like configurations in the above embodiments are designated with like reference signs, and their explanations are omitted.

As shown in FIGS. 18 and 19, the display apparatus according to the seventh embodiment has the first display panel 4 and the second display panel 5 connected via a chip-on-film (COF) 141 having the driving circuit 31 mounted on the inter-panel FPC 43. Like in the sixth embodiment, the source electrodes c_1 to c_100 as the first electrode 2 and the gate electrodes r_1 to r_80 as the third electrode are connected to the same driving circuit 31. The one driving circuit 31 drives the source electrodes and the gate electrodes. Because the second display panel 5 is smaller than the first display panel 4, as shown in FIG. 20, the integrated circuit that constitutes the driving circuit 31 is mounted on the portion of the COF 141 which comes to the side of the second display panel 5 when folded, although the configuration is not specifically limited to this.

The COF 141 has plural pairs of electrodes on both sides of a polyimide resin film. The electrodes on the front surface are electrically connected to the electrodes on the back surface, that are disposed opposite to the electrodes on the front surface, via a through-hole 145 that passes through the polyimide film. Pair of electrodes that are electrically connected on the front and back surfaces are electrically connected to the same output terminal of the driving circuit 31. For example, the electrodes on the front surface are electrically connected to the source electrode or the gate electrode of the first display panel 4, and the electrodes on the back surface are electrically connected to the source electrode or the gate electrode of the second display panel 5.

The inter-panel switching element 91 that controls on and off of the driving signal applied from the driving circuit 31 to the first display panel 4 between the COF 141 and the first display panel 4 is provided on the first display panel 4. This similarly applies to the second display panel 5. The inter-panel switching element 91 that controls on and off of the driving signal applied from the driving circuit 31 to the second display panel 4 is provided on the second display panel 5.

A chip part 142 like a booster capacitor of the driving circuit 31 is mounted on the COF 141. The FPC input electrode 36 is provided on the COF 141. Various signals are applied from an external circuit (not shown) to the driving circuit 31 via the FPC input electrode 36. The FPC input electrode 36 is also used to apply a power source voltage to the driving circuit 31 and to connect the booster capacitor. A light-emitting diode (LED) element 146 for backlight (an LED mounting part 147 in FIG. 19) is mounted on the COF 141. The LED element 146 is connected to the driving circuit 31 via the electrode of the COF 141, and is driven by the driving circuit 31.

### Eighth Embodiment

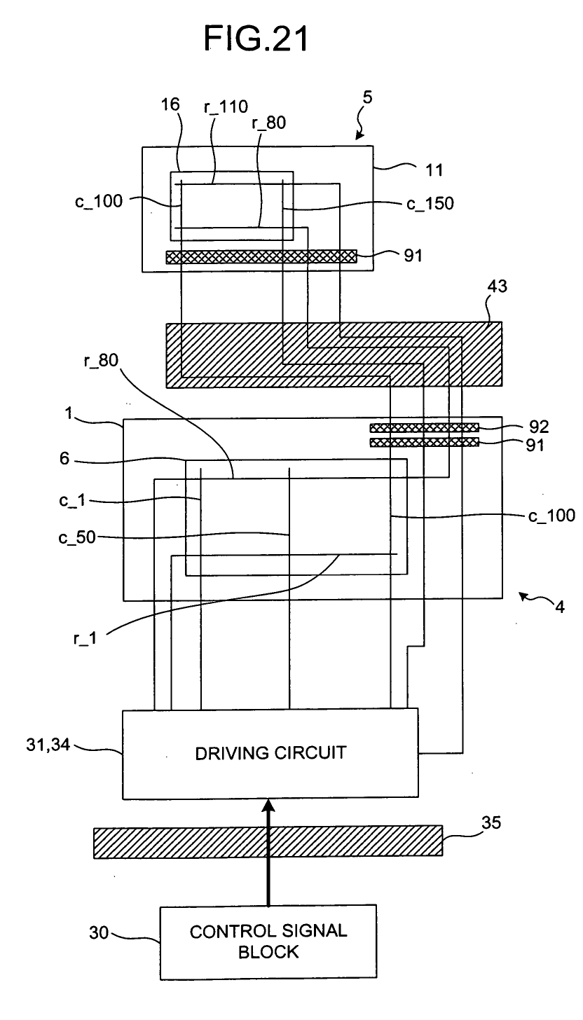

FIG. 21 is a schematic top plan view of display panels according to an eighth embodiment of the present invention, which are developed in plane. In FIG. 21, sealing portions of the first and the second display panels 4 and 5 are omitted, to avoid complexity of the diagram. Like configurations in the above embodiments are designated with like reference signs, and their explanations are omitted. The display apparatus according to the eighth embodiment has source electrodes c_1 to c_150 and gate electrodes r_1 to r_110. Among these electrodes, the source electrodes c_1 to c_100 and the gate electrodes r_1 to r_80 are used to drive the first display panel 4. The source electrodes c_100 to c_150 and the gate electrodes r_80 to r_110 are used to drive the second display panel 5.

A part of the source electrodes to drive the second display panel 5 (c_100 in the example shown) is electrically connected to the corresponding electrode (c_100 in the example shown) of the first display panel 4 via the protection element 92 and the inter-panel switching element 91. A part of the gate electrodes to drive the second display panel 5 (r_80 in the example shown) is electrically connected to the corresponding electrode (r_80 in the example shown) of the first display panel 4 via the protection element 92 and the inter-panel switching element 91.

Among the source electrodes to drive the second display panel 5, the source electrodes other than the one that is electrically connected to the source electrode of the first display panel 4 (c_101 to c_150 which are omitted in the example shown) are electrically connected to the driving circuit 31 via the protection element 92 and the inter-panel switching element 91. Among the gate electrodes to drive the second display panel 5, the gate electrodes other than the one that is electrically connected to the gate electrode of the first display panel 4 (r_81 to r_110 which are omitted in the example shown) are electrically connected to the driving circuit 34 via the protection element 92 and the inter-panel switching element 91. Based on this configuration, the second display panel 5 can display contents different from those of the first display panel 4.

### Ninth Embodiment

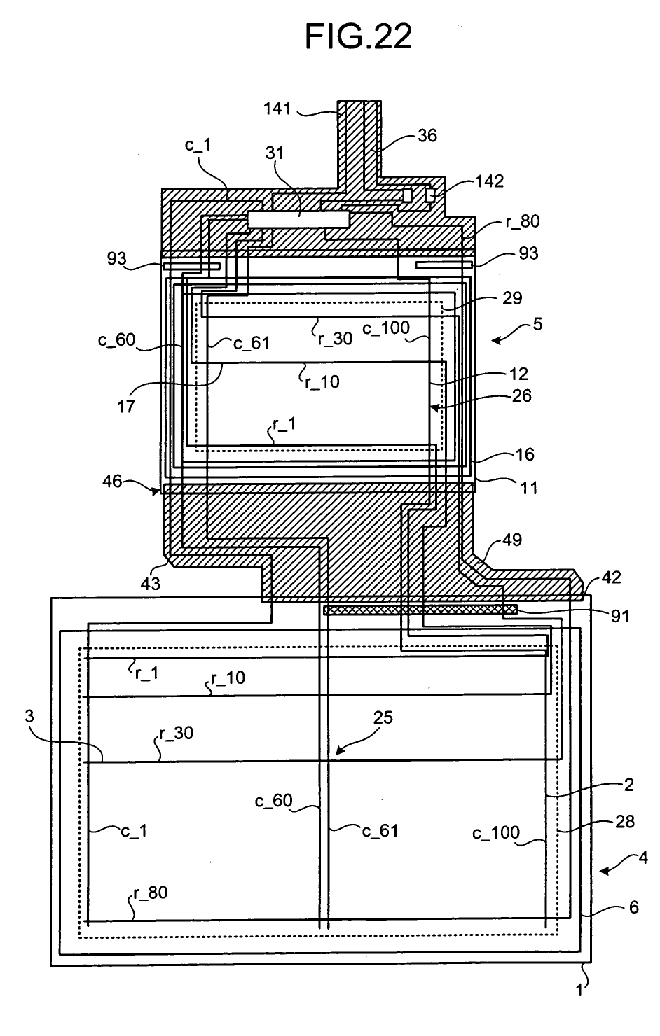

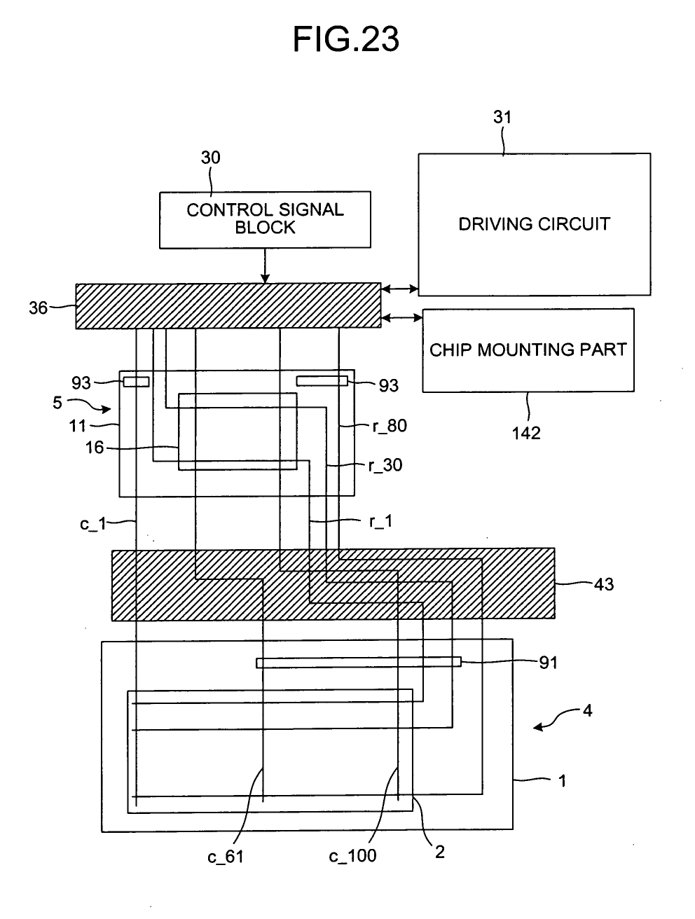

FIG. 22 is a top plan view of a main part of display panels according to a ninth embodiment of the present invention, which is developed in plane. FIG. 23 is a schematic top plan view of the display panels. In FIG. 22, sealing portions of the first and the second display panels 4 and 5 are omitted, to avoid complexity of the diagram. Like configurations in the above embodiments are designated with like reference signs, and their explanations are omitted.

As shown in FIGS. 22 and 23, the display panel according to the ninth embodiment has the following configuration. Among the source electrodes c_1 to c_100 of the fourth embodiment shown in FIG. 11 that are connected to the driving circuit 31, the source electrodes that do not pass through the display area 29 of the second display panel 5 (c_1 to c_60 in the example shown) are, in the ninth embodiment, electrically connected to the corresponding source electrodes (c_1 to c_60 in the example shown) of the first display panel via the switching element 93 provided on the second display panel 5, detouring around the display area 29 of the second display panel 5. This similarly applies to the gate electrodes. Among the gate electrodes r_1 to r_80 that are connected to the driving circuit 31, the gate electrodes that do not pass through the display area 29 of the second display panel 5 (r_31 to r_80 in the example shown) are electrically connected to the corresponding source electrodes (r_{—}³¹ to r_80 in the example shown) of the first display panel 4 via the switching element 93 provided on the second display panel 5, detouring around the display area 29 of the second display panel 5.

The source electrodes that pass through the display area 29 of the second display panel 5 (c_61 to c_100 in the example shown) are electrically connected to the corresponding source electrodes (c_61 to c_100 in the example shown) of the first display panel 4 via the inter-panel switching element 91 provided on the first display panel 4. The gate electrodes that pass through the display area 29 of the second display panel 5 (r_1 to r_30 in the example shown) are electrically connected to the corresponding gate electrodes (r_1 to r_30 in the example shown) of the first display panel 4 via the inter-panel switching element 91 provided on the first display panel 4.

The configuration and the operation of the switching element 93 provided on the second display panel 5 are the same as those of the inter-panel switching element 91 provided on the first display panel 4. In other words, when the display of the first display panel 4 is not necessary, the inter-panel switching element 91 and the switching element 93 are turned off. When the display of the first display panel 4 is necessary, the inter-panel switching element 91 and the switching element 93 are turned on.

When the display of the first display panel 4 is not necessary based on the above configuration, the display of the first display panel 4 can be turned off, thereby substantially reducing power consumption. The display apparatus can have a protection element that disperses static electricity generated in the each of source and gate electrodes, the inter-panel switching element 91, and the switching element 93.

(Connection Configuration of the Active Matrix Liquid Crystal Display Panel and the Passive Matrix Liquid Crystal Display Panel)

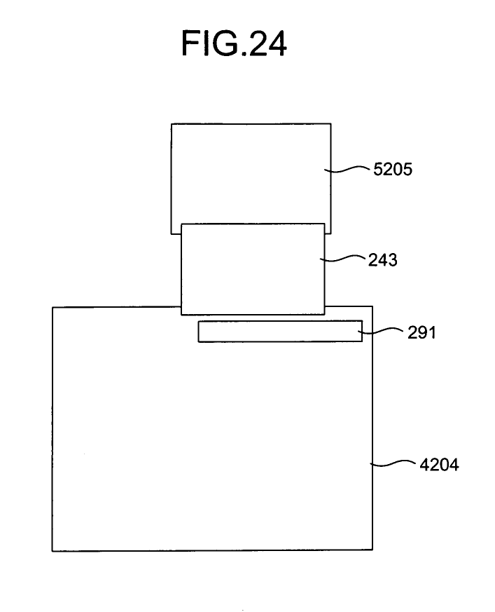

FIG. 24 is a schematic top plan view of display panels according to tenth to thirteenth embodiments of the present invention, which are developed in plane. As shown in FIG. 24, the display panel according to the tenth to the thirteenth embodiments has a first display panel 4204 and a second display panel 5205 connected with an inter-panel connector 243. An inter-panel switching element 291 having a signal conversion function of converting a driving signal for driving the first display panel 4204 into a signal for driving the second display panel 5205 is provided near the inter-panel connector on the first display panel 4204, in a similar manner as the inter-panel switching element 91 according to the third embodiment shown in FIG. 9.

While not shown in FIG. 24, electro-optic display mediums, and plural source electrodes and plural gate electrodes to supply driving signals to the electro-optic display mediums are provided on the first display panel 4204 and the second display panel 5205, respectively. Driving circuits (corresponding to the driving circuits 31 and 34 according to the first to the ninth embodiments) that drive the first and the second display panels 5204 and 5205 are provided on the substrate that constitutes the first display panel 4204. All source electrodes and all gate electrodes of the first display panel 4204 are connected to the driving circuit. A part of the source electrodes and a part of the gate electrodes of the first display panel 4204 are electrically connected to a corresponding source electrode and a corresponding gate electrode of the second display panel 5205 via the inter-panel switching element 291 respectively.

### Tenth Embodiment

According to a tenth embodiment, the first display panel 4204 in the configuration shown in FIG. 24 is an active matrix liquid crystal display panel having a thin-film transistor having a polysilicon semiconductor layer in each pixel unit, and the second display panel 5205 is a passive matrix STN (super twisted nematic) liquid crystal display panel. A reference numeral 243 denotes a connector.

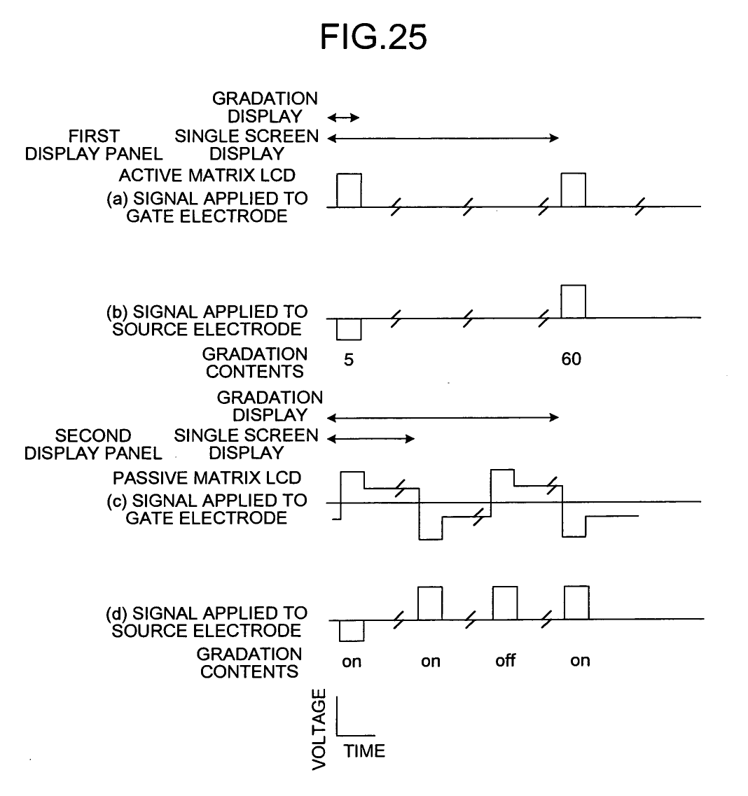

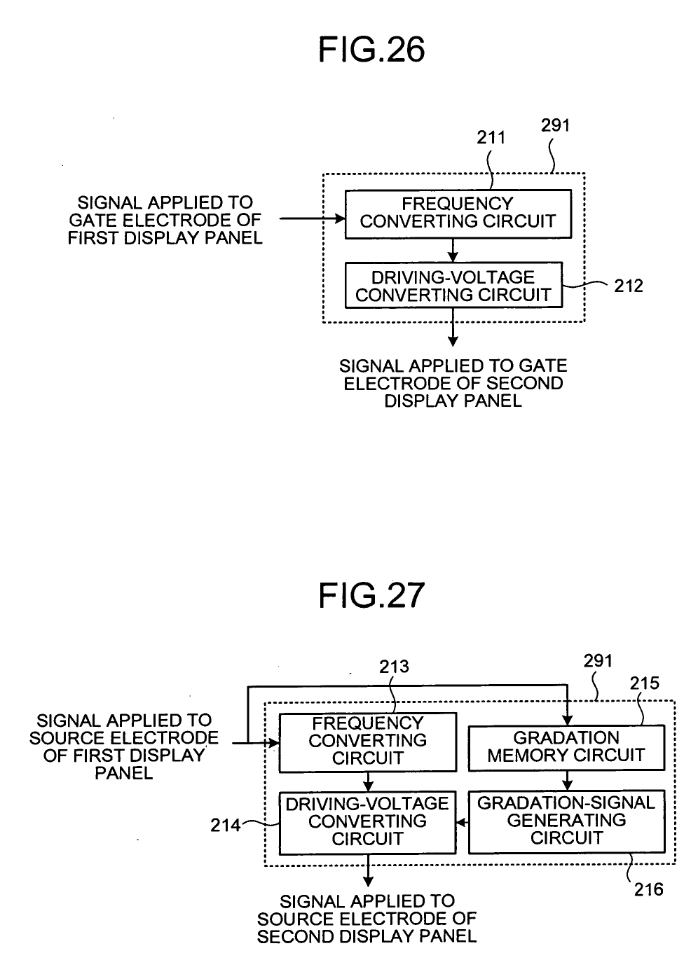

FIG. 25 is a waveform diagram for explaining a signal conversion between display panels according to the tenth embodiment of the present invention. FIGS. 26 and 27 are block diagrams of a schematic configuration of an inter-panel switching element that converts a signal between the display panels according to the tenth embodiment of the present invention. FIG. 26 is a conversion block diagram of a signal applied to a gate electrode, and FIG. 27 is a conversion block diagram of a signal applied to a source electrode.

As shown in FIG. 25, the first display panel 4204 employs a voltage amplitude modulation gradation method for displaying gradation by controlling the amplitude of a signal voltage applied to the source electrode ((b) in FIG. 25). To prevent degradation of a liquid crystal, an alternate current driving is carried out that inverts the polarity of a signal voltage applied to the source electrode for each display of a single screen ((b) in FIG. 25). On the other hand, the second display panel 5205 employs a frame rate control gradation method for displaying gradation according to the on/off ratio of plural continuous screens (frames) ((d) in FIG. 25).

The second display panel 5205 needs to display plural screens (frames) within a time required to display a single screen of the first display panel 4204, and therefore, has a higher driving frequency than that of the first display panel 4204. On the second display panel 5205, the amplitude of the signal voltage applied to the source electrode is constant ((d) in FIG. 25). On the second display panel 5205, the polarity of the signal voltage applied to the gate electrode is inverted to carry out the alternate current driving ((c) in FIG. 25).

In order to carry out the signal conversion, as shown in FIG. 26, a gate signal frequency converting circuit 211 that constitutes the inter-panel switching element 291 converts the frequency of the signal applied to the gate electrode of the first display panel 4204 into a frequency suitable for driving the second display panel 5205. A gate driving voltage converting circuit 212 that constitutes the inter-panel switching element 291 converts the voltage of the frequency-converted signal into an alternate current voltage suitable for driving the second display panel 5205. As explained above, the signal ((a) in FIG. 25) applied to the gate electrode of the first display panel 4204 is converted into a signal ((c) in FIG. 25) of a suitable waveform to be applied to the gate electrode of the second display panel 5205, and this converted signal is applied to the gate electrode of the second display panel 5205.

As shown in FIG. 27, a source signal frequency converting circuit 213 that constitutes the inter-panel switching element 291 converts the frequency of the signal applied to the source electrode of the first display panel 4204 into a frequency suitable for driving the second display panel 5205. A source driving voltage converting circuit 214 that constitutes the inter-panel switching element 291 converts the voltage of the frequency-converted signal into a voltage suitable for driving the second display panel 5205. In converting the voltage, to display the gradation, plural continuous screens (frames) corresponding to a single screen of the first display panel 4204 are on/off controlled.

To on/off control the plural continuous screens (frames), a gradation memory circuit 215 and a gradation signal generating circuit 216 are provided in the conversion block of the signal applied to the source electrode of the inter-panel switching element 291. The amplitude of the signal voltage applied to the source electrode of the first display panel 4204 is stored, as gradation information, into the gradation memory circuit 215. Based on the stored gradation information, the gradation signal generating circuit 216 generates a gradation signal for on/off controlling the plural continuous screens (frames).

The source driving voltage converting circuit 214 generates a signal of a polarity opposite to that of the signal applied to the gate electrode of the second display panel 5205 when display is turned on for the screen (frame), according to the gradation signal. The source driving voltage converting circuit 214 generates a signal of a polarity same as that of the signal applied to the gate electrode of the second display panel 5205 when display is turned off for the screen (frame). As explained above, the signal ((b) in FIG. 25) applied to the source electrode of the first display panel 4204 is converted into a signal ((d) in FIG. 25) of a suitable waveform to be applied to the source electrode of the second display panel 5205, and the converted signal is applied to the source electrode of the second display panel 5205.

The gate signal frequency converting circuit 211, the gate driving voltage converting circuit 212, the source signal frequency converting circuit 213, the source driving voltage converting circuit 214, the gradation memory circuit 215, and the gradation signal generating circuit 216 can be configured according to techniques publicly known.

(Connection Configuration of the Liquid Crystal Display Panel and the Organic LED Display Panel)

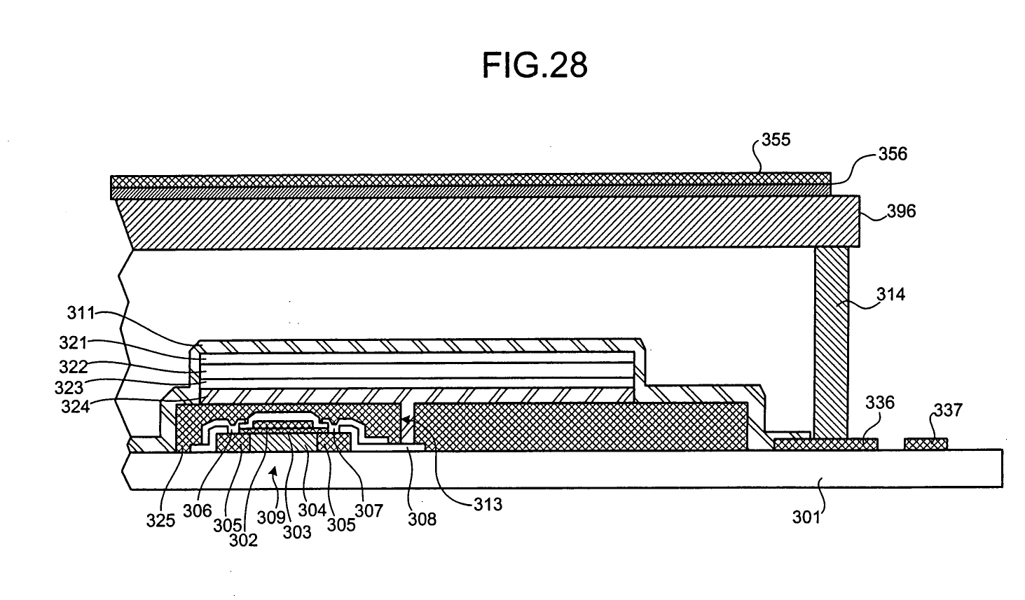

FIG. 28 is an enlarged cross-section of a part of an organic LED display panel according to an eleventh and subsequent embodiments of the present invention (the configuration according to an eleventh embodiment is slightly different from others because of a different driving system). As shown in FIG. 28, a thin-film transistor 309 is formed on one of the substrates 301. The thin-film transistor 309 includes a semiconductor layer 304 made of polysilicon (or amorphous silicon) laminated on the substrate 301, an impurity doped area 305 that becomes a source area and a drain area formed on both sides of the semiconductor layer 304, a gate electrode 302, a source electrode 306, and a drain electrode 307 laminated on the semiconductor layer 304 via a gate insulation film 303.

The drain electrode 307 is connected to a cathode electrode 324 provided on an inter-layer insulation film 325 that covers the thin-film transistor 309, via a drain connection electrode 308, and a contact 313 that passes through the inter-layer insulation film 325. A light-emitting layer 323 is laminated on the cathode electrode 324. An anode electrode 321 is laminated on the light-emitting layer 323 via an electron transfer layer 322. A protection film 311 covers the thin-film transistor 309, the inter-layer insulation film 325, the cathode electrode 324, the light-emitting layer 323, the electron transfer layer 322, and the anode electrode 321.

A glass substrate 396 is disposed opposite to the substrate 301 on which the LED element having the above configuration is formed. A retardation film 356 and a polarizing film 355 are laminated on the glass substrate 396. A gap between the glass substrate 396 and the substrate 301 is sealed with a sealing portion 314. A connection electrode 336 mounted with a driving circuit (not shown) that applies a predetermined signal to the gate electrode 302 or the source electrode 306, and an input electrode 337 that is connected to an external circuit that applies a predetermined signal to the driving circuit are formed on the substrate 301.

### Eleventh Embodiment

According to the eleventh embodiment, the first display panel 204 in the configuration shown in FIG. 24 is an active matrix liquid crystal display panel including a thin-film transistor made of a polysilicon semiconductor layer in each pixel unit, and the second display panel 205 is a passive matrix organic LED display panel. The electrode on the connection member 243 is connected to the connection electrode 336 on the organic LED display panel 5205 in the configuration shown in FIG. 28. The input electrode 337 is not provided. Because the organic LED display panel is a passive matrix type, the thin-film transistor 309 is not provided on the substrate 301. The configuration of the passive matrix type LED display panel is publicly known, and therefore, a diagram and a detailed explanation are omitted.

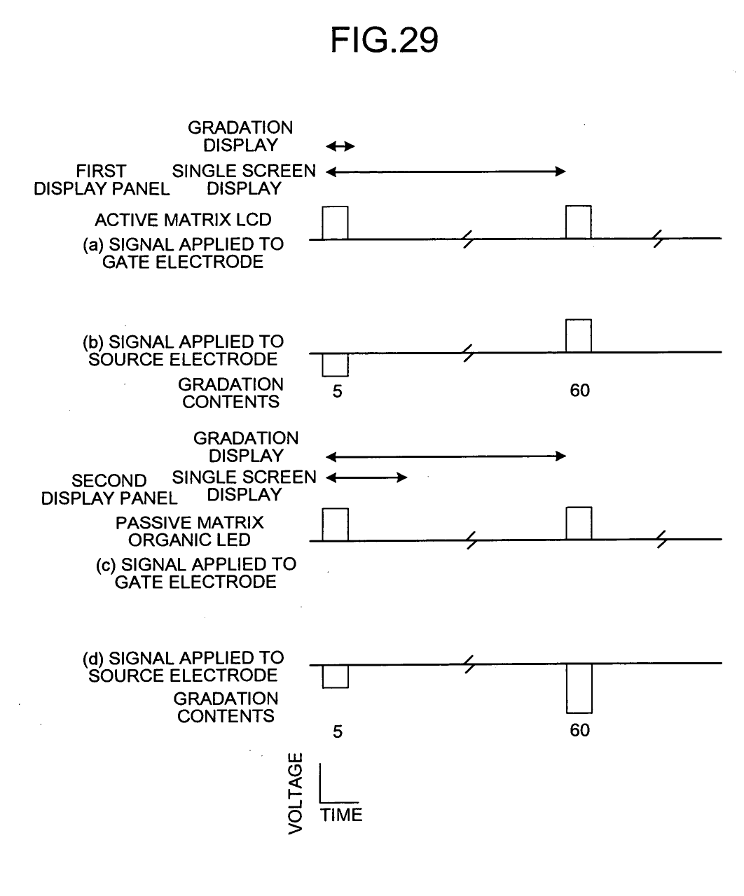

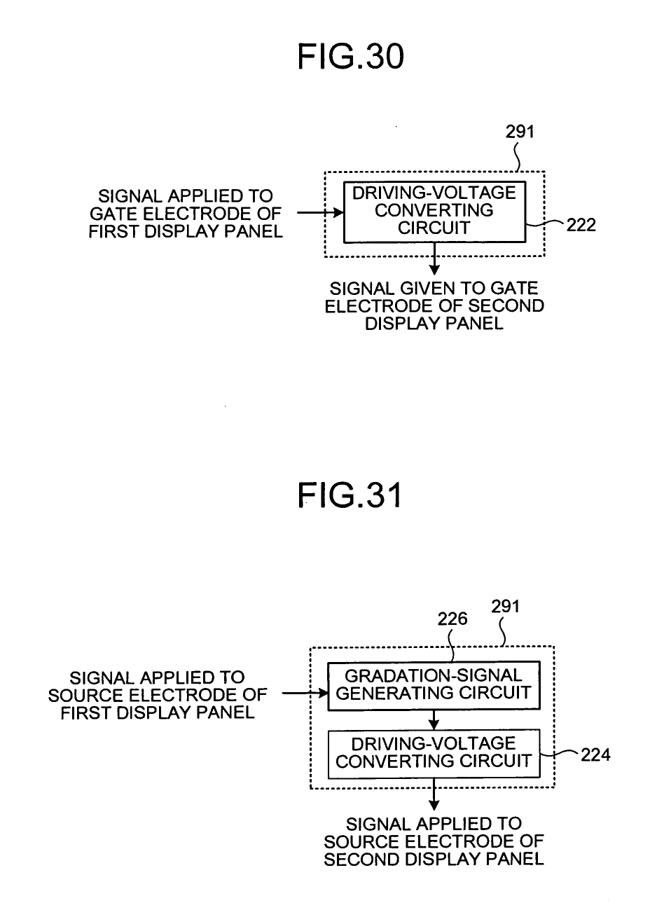

FIG. 29 is a waveform diagram for explaining a signal conversion between display panels according to the eleventh embodiment of the present invention. FIGS. 30 and 31 are block diagrams of a schematic configuration of an inter-panel switching element that converts a signal between the display panels according to the eleventh embodiment of the present invention. FIG. 30 is a conversion block diagram of a signal applied to the gate electrode, and FIG. 31 is a conversion block diagram of a signal applied to the source electrode.

As shown in FIG. 29, the first display panel 4204 employs a voltage amplitude modulation gradation method and an alternate current driving ((b) in FIG. 29) for the signal applied to the source electrode, like in the tenth embodiment. On the other hand, the second display panel 5205 employs a voltage amplitude modulation gradation method for the signal applied to the source electrode. For the second display panel 5205, degradation of liquid crystal does not need to be taken into consideration. Therefore, a direct current driving is carried out to the source electrode ((d) in FIG. 29).

In carrying out the signal conversion, frequency conversion is not necessary. Therefore, as shown in FIG. 30, a gate driving voltage converting circuit 222 that constitutes the inter-panel switching element 291 converts the voltage of the signal applied to the gate electrode of the first display panel 4204 into a voltage suitable for driving the second display panel 5205. As explained above, the signal ((a) in FIG. 29) applied to the gate electrode of the first display panel 4204 is converted into a signal ((c) in FIG. 29) of a suitable waveform to be applied to the gate electrode of the second display panel 5205, and the converted signal is applied to the gate electrode of the second display panel 5205.

As shown in FIG. 31, a gradation signal generating circuit 226 that constitutes the inter-panel switching element 291 generates a gradation signal based on the amplitude of the signal voltage applied to the source electrode of the first display panel 4204. A source driving voltage converting circuit 224 adjusts the voltage amplitude of the signal applied to the source electrode of the second display panel 5205, according to the gradation signal. As explained above, the signal ((b) in FIG. 29) applied to the source electrode of the first display panel 4204 is converted into a signal ((d) in FIG. 29) of a suitable waveform to be applied to the source electrode of the second display panel 5205, and the converted signal is applied to the source electrode of the second display panel 5205. The gate driving voltage converting circuit 222, the source driving voltage converting circuit 224, and the gradation signal generating circuit 226 can be configured according to techniques publicly known.

### Twelfth Embodiment

According to a twelfth embodiment, the first display panel 4204 in the configuration shown in FIG. 24 is an active matrix organic LED display panel including a thin-film transistor made of a polysilicon semiconductor layer in the configuration shown in FIG. 28, and the second display panel 5205 is a passive matrix STN liquid crystal display panel.

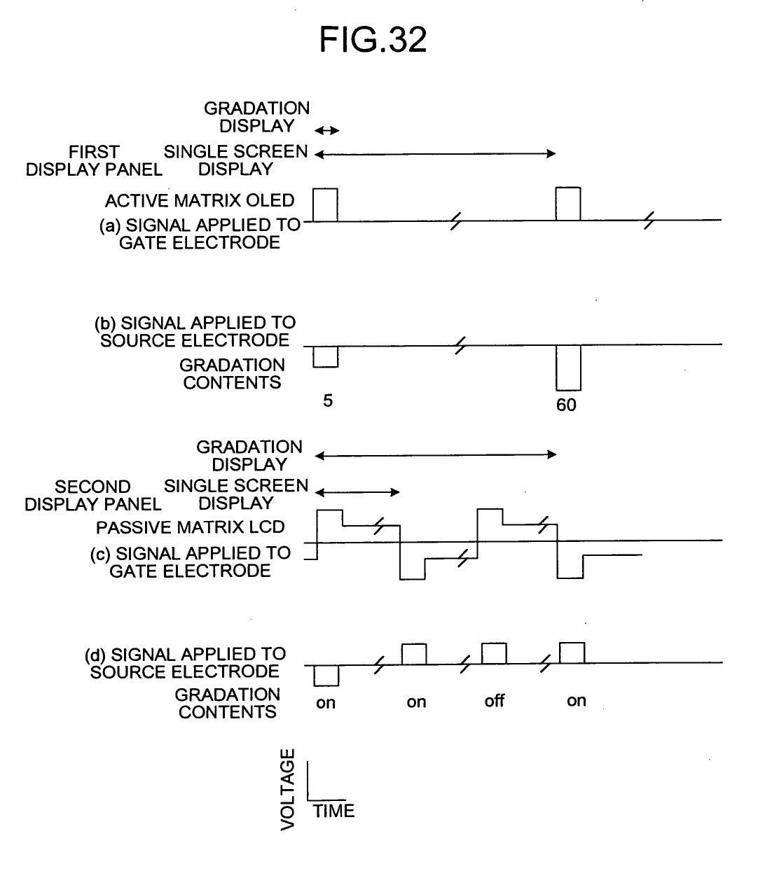

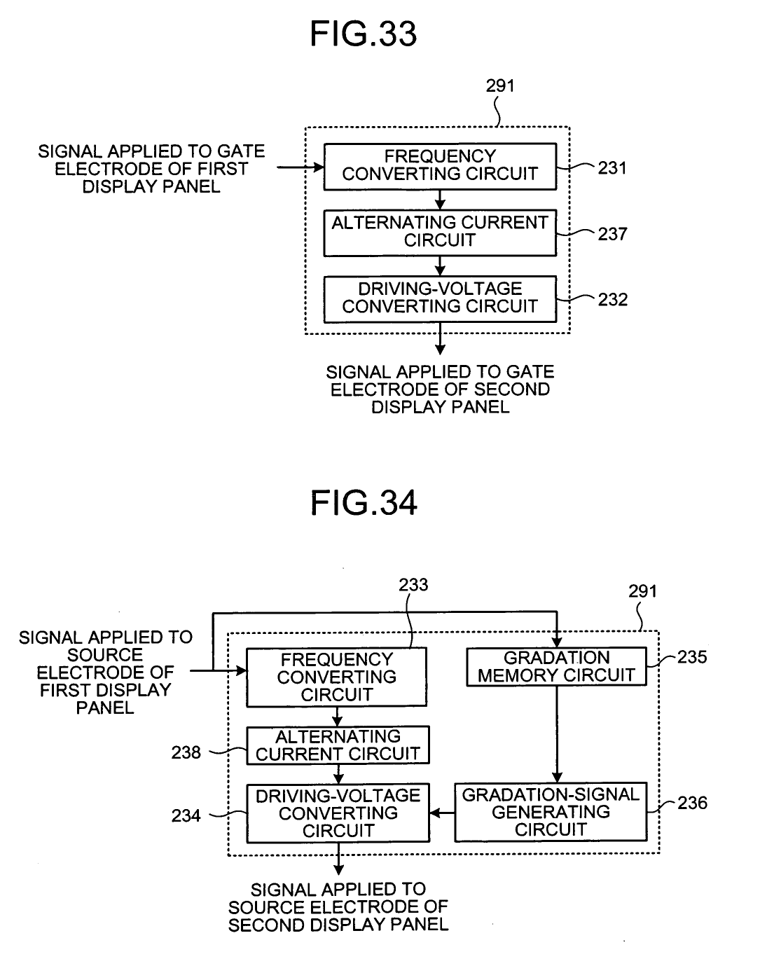

FIG. 32 is a waveform diagram for explaining a signal conversion between display panels according to the twelfth embodiment of the present invention. FIGS. 33 and 34 are block diagrams of a schematic configuration of an inter-panel switching element that converts a signal between the display panels according to the twelfth embodiment of the present invention. FIG. 33 is a conversion block diagram of a signal applied to the gate electrode, and FIG. 34 is a conversion block diagram of a signal applied to the source electrode.

As shown in FIG. 32, the first display panel 4204 employs a voltage amplitude modulation gradation method and a direct current driving ((b) in FIG. 32) for the signal applied to the source electrode. On the other hand, the second display panel 5205 employs a frame rate control gradation method and an alternate current driving, as explained in the tenth embodiment ((d) in FIG. 32). Therefore, the second display panel 5205 needs to display plural screens (frames) within a time required to display a single screen of the first display panel 4204, and therefore, has a higher driving frequency than that of the first display panel 4204. On the second display panel 5205, the amplitude of the signal voltage applied to the source electrode is constant ((d) in FIG. 32). On the second display panel 5205, the polarity of the signal voltage applied to the gate electrode is inverted to carry out the alternate current driving ((c) in FIG. 32).

To carry out the signal conversion, as shown in FIG. 33, a gate signal frequency converting circuit 231 that constitutes the inter-panel switching element 291 converts the frequency of the signal applied to the gate electrode of the first display panel 4204 into a frequency suitable for driving the second display panel 5205. An alternating current circuit 237 that constitutes the inter-panel switching element 291 converts the direct current voltage of the frequency-converted signal into an alternate current voltage. A gate driving voltage converting circuit 232 that constitutes the inter-panel switching element 291 converts the voltage of the alternate-current converted signal into a voltage suitable for driving the second display panel 5205. As explained above, the signal ((a) in FIG. 32) applied to the gate electrode of the first display panel 4204 is converted into a signal ((c) in FIG. 32) of a suitable waveform to be applied to the gate electrode of the second display panel 5205, and the converted signal is applied to the gate electrode of the second display panel 5205.

As shown in FIG. 34, a source signal frequency converting circuit 233 that constitutes the inter-panel switching element 291 converts the frequency of the signal applied to the source electrode of the first display panel 4204 into a frequency suitable for driving the second display panel 5205. An alternating current circuit 238 that constitutes the inter-panel switching element 291 converts the direct current voltage of the frequency-converted signal into an alternate current voltage. A source driving voltage converting circuit 234 that constitutes the inter-panel switching element 291 converts the voltage of the alternate-current converted signal into a voltage suitable for driving the second display panel 5205. In converting the voltage, to display the gradation, a gradation memory circuit 235 and a gradation signal generating circuit 236 that constitute the inter-panel switching element 291 adjust on and off of plural continuous screens (frames) corresponding to a single screen of the first display panel 4204, in a similar manner to that according to the tenth embodiment.

As explained above, the signal ((b) in FIG. 32) applied to the source electrode of the first display panel 4204 is converted into a signal ((d) in FIG. 32) of a suitable waveform to be applied to the source electrode of the second display panel 5205, and the converted signal is applied to the source electrode of the second display panel 5205. The gate signal frequency converting circuit 231, the gate driving voltage converting circuit 232, the source signal frequency converting circuit 233, the source driving voltage converting circuit 234, the gradation memory circuit 235, the gradation signal generating circuit 236, and the alternating current circuits 237 and 238 can be configured according to techniques publicly known.

### Thirteenth Embodiment

According to the thirteenth embodiment, the first display panel 4204 in the configuration shown in FIG. 24 is an active matrix organic LED display panel including a thin-film transistor made of a polysilicon semiconductor layer in the configuration shown in FIG. 28, and the second display panel 5205 is an active matrix liquid crystal display panel including a thin-film transistor made of an amorphous polysilicon semiconductor layer in each pixel.

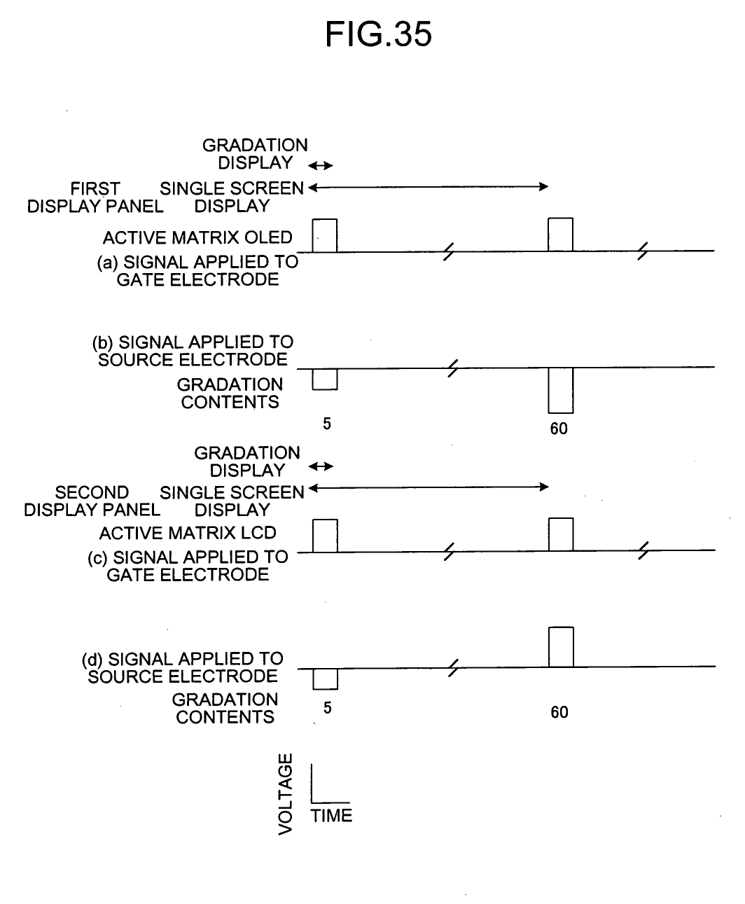

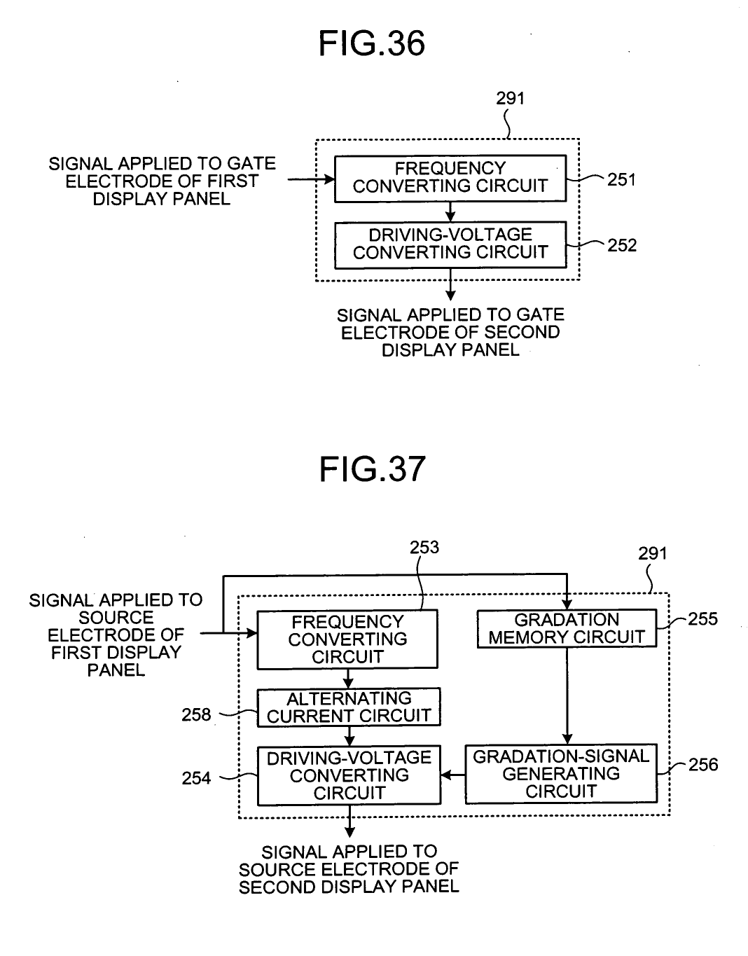

FIG. 35 is a waveform diagram for explaining a signal conversion between display panels according to the thirteenth embodiment of the present invention. FIGS. 36 and 37 are block diagrams of a schematic configuration of an inter-panel switching element that converts a signal between the display panels according to the thirteenth embodiment of the present invention. FIG. 36 is a conversion block diagram of a signal applied to the gate electrode, and FIG. 37 is a conversion block diagram of a signal applied to the source electrode.

As shown in FIG. 35, the first display panel 4204 employs a voltage amplitude modulation gradation method and a direct current driving ((b) in FIG. 35) for the signal applied to the source electrode. On the other hand, the second display panel 5205 employs a voltage amplitude modulation gradation method and an alternate current driving, for the signal applied to the source electrode.

To carry out the signal conversion, as shown in FIG. 36, a gate signal frequency converting circuit 251 that constitutes the inter-panel switching element 291 converts the frequency of the signal applied to the gate electrode of the first display panel 4204 into a frequency suitable for driving the second display panel 5205. A gate driving voltage converting circuit 252 that constitutes the inter-panel switching element 291 converts the voltage of the frequency-converted signal into a voltage suitable for driving the second display panel 5205. As explained above, the signal ((a) in FIG. 35) applied to the gate electrode of the first display panel 4204 is converted into a signal ((c) in FIG. 35) of a suitable waveform to be applied to the gate electrode of the second display panel 5205, and the converted signal is applied to the gate electrode of the second display panel 5205.

As shown in FIG. 37, a source signal frequency converting circuit 253 that constitutes the inter-panel switching element 291 converts the frequency of the signal applied to the source electrode of the first display panel 4204 into a frequency suitable for driving the second display panel 5205. An alternating current circuit 258 that constitutes the inter-panel switching element 291 converts the direct current voltage of the frequency-converted signal into an alternate current voltage. A source driving voltage converting circuit 254 that constitutes the inter-panel switching element 291 converts the voltage of the alternate-current converted signal into a voltage suitable for driving the second display panel 5205.

In converting the voltage, to display the gradation, the gradation memory circuit 255 that constitutes the inter-panel switching element 291 stores the amplitude of the signal voltage applied to the source electrode of the first display panel 4204, as gradation information. Based on the stored gradation information, the gradation signal generating circuit 256 generates the gradation signal for adjusting the amplitude of the voltage signal applied to the source electrode of the second display panel 5205. According to the gradation signal, the source driving voltage converting circuit 254 adjusts the amplitude, that is, the voltage level, of the voltage signal applied to the source electrode of the second display panel 5205.

As explained above, the signal ((b) in FIG. 35) applied to the source electrode of the first display panel 4204 is converted into a signal ((d) in FIG. 35) of a suitable waveform to be applied to the source electrode of the second display panel 5205, and the converted signal is applied to the source electrode of the second display panel 5205. The gate signal frequency converting circuit 251, the gate driving voltage converting circuit 252, the source signal frequency converting circuit 253, the source driving voltage converting circuit 254, the gradation memory circuit 255, the gradation signal generating circuit 256, and the alternating current circuits 257 and 258 can be configured according to techniques publicly known.

Although not particularly shown, in the configuration shown in FIG. 24, the first display panel 4204 can be an active matrix organic LED display panel including a thin-film transistor made of a polysilicon semiconductor layer in the configuration shown in FIG. 28, and the second display panel 5205 can be an active matrix or passive matrix organic LED display panel. In this case, the inter-panel switching element 291 does not need to carry out a signal conversion such as a frequency conversion or a driving voltage conversion. Therefore, the inter-panel switching element 291 simply controls on and off of a driving signal supplied to the second display panel 5.

(Configuration Having Three or More Display Panels)

### Fourteenth Embodiment

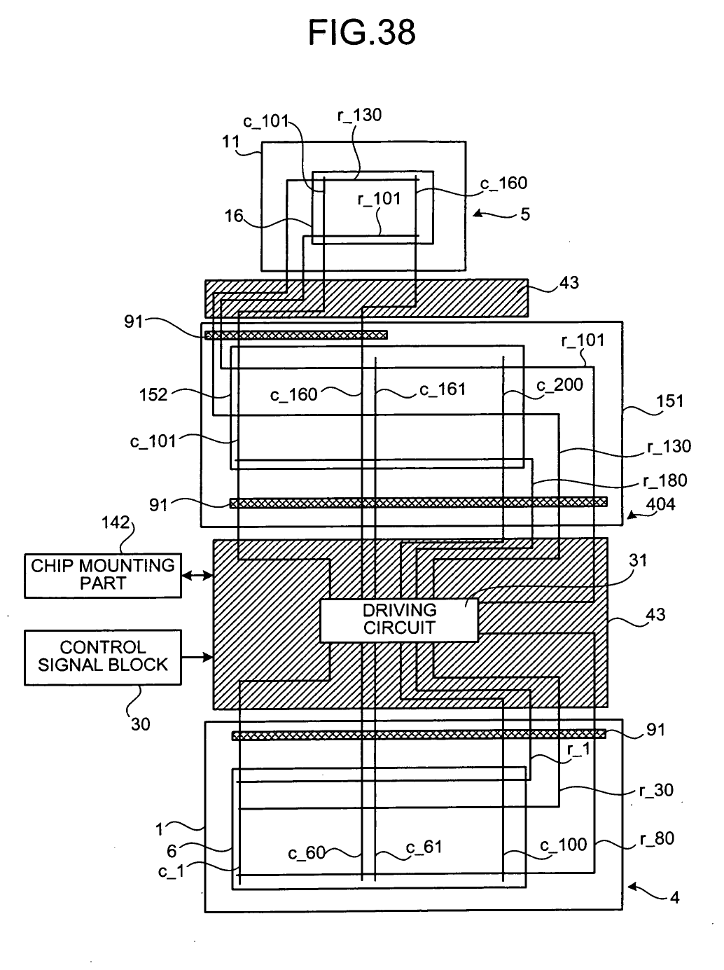

FIG. 38 is a schematic top plan view of display panels according to a fourteenth embodiment of the present invention, which are developed in plane. Like configurations in the above embodiments are designated with like reference signs, and their explanations are omitted. As shown in FIG. 38, the display apparatus according to the fourteenth embodiment has three display panels. A third display panel 404 including a fifth substrate 151 and a sixth substrate 152, which are opposite to each other, is provided between the first display panel 4 and the second display panel 5.

The third display panel 404 is connected to the first display panel 4 via an inter-panel FPC 43 (designated as “first inter-panel FPC 43”, for classification). The driving circuit 31 that drives the source electrodes and the gate electrodes of the first to the third display panels 4, 5, and 404 is mounted on the first inter-panel FPC 43. The third display panel 404 is connected to the second display panel 5 via another inter-panel FPC 43 (designated as “second inter-panel FPC 43”).

According to the fourteenth embodiment, although not particularly limited, 200 source electrodes c_1 to c_200 and 180 gate electrodes r_1 to r_180 are connected to the driving circuit 31. The source electrodes c_1 to c_100 are electrically connected to the source electrodes in the display area of the first display panel 4 via electrodes (not shown) on the first inter-panel FPC 43 and the inter-panel switching element 91 provided on the first substrate 1 of the first display panel 4. Similarly, the gate electrodes r_1 to r_80 are electrically connected to the gate electrodes in the display area of the first display panel 4 via electrodes (not shown) on the first inter-panel FPC 43 and the inter-panel switching element 91 provided on the first substrate 1.

The source electrodes c_101 to c_200 are electrically connected to the source electrodes in the display area of the third display panel 404 via electrodes (not shown) on the first inter-panel FPC 43 and the inter-panel switching element 91 provided on the fifth substrate 151 of the third display panel 404. Similarly, the gate electrodes r_101 to r_180 are electrically connected to the gate electrodes in the display area of the third display panel 404 via electrodes (not shown) on the first inter-panel FPC 43 and the inter-panel switching element 91 provided on the fifth substrate 151.

Among the source electrodes c_101 to c_200 of the third display panel 404, c_101 to c_160 are electrically connected to the source electrodes in the display area of the second display panel 5 via the inter-panel switching element 91 on the fifth substrate 151 (or the third substrate 11 of the second display panel 5) and electrodes (not shown) on the second inter-panel FPC 43. Similarly, among the gate electrodes r_101 to r_180 of the third display panel 404, r_101 to r_130 are electrically connected to the gate electrodes in the display area of the second display panel 5 via the inter-panel switching element 91 on the fifth substrate 151 (or the third substrate 11) and electrodes (not shown) on the second inter-panel FPC 43.

Based on the above configuration, in addition to the display contents of the first display panel 4 and the second display panel 5, different information is displayed on the third display panel 404, thereby increasing the amount of information that can be displayed. Therefore, this has an effect that the display apparatus can be used for various purposes. For example, Internet information is displayed on the first display panel 4 or the second display panel 5, and by referring to this information, the third display panel 404 is used to create an e-mail or display a received e-mail.

### Fifteenth Embodiment

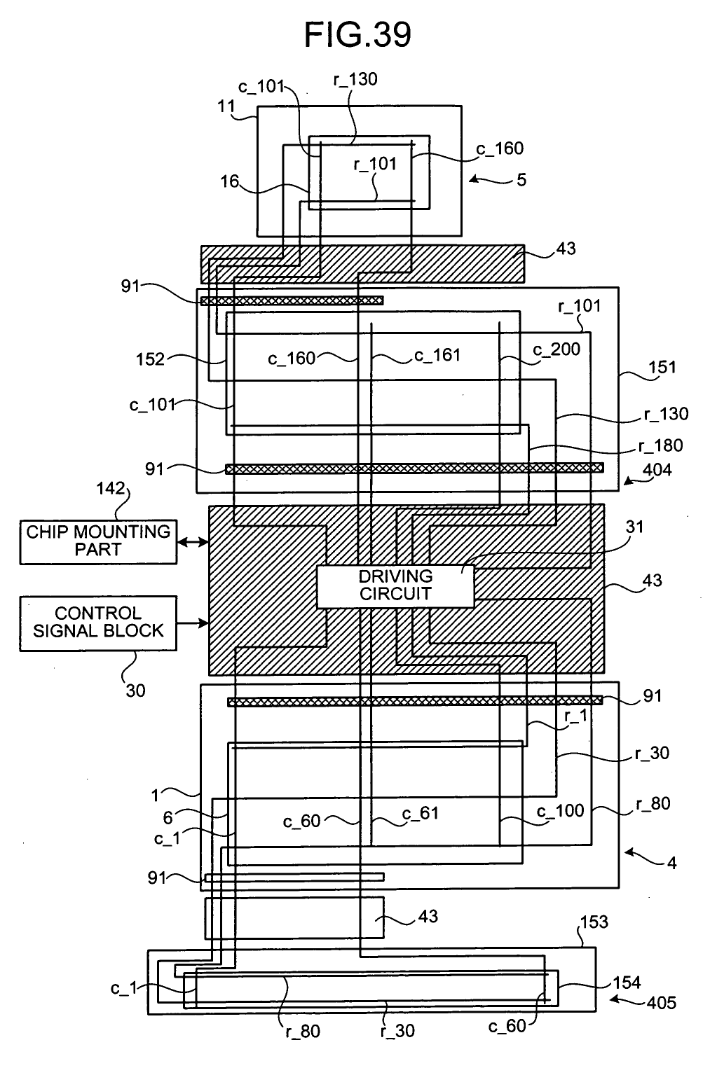

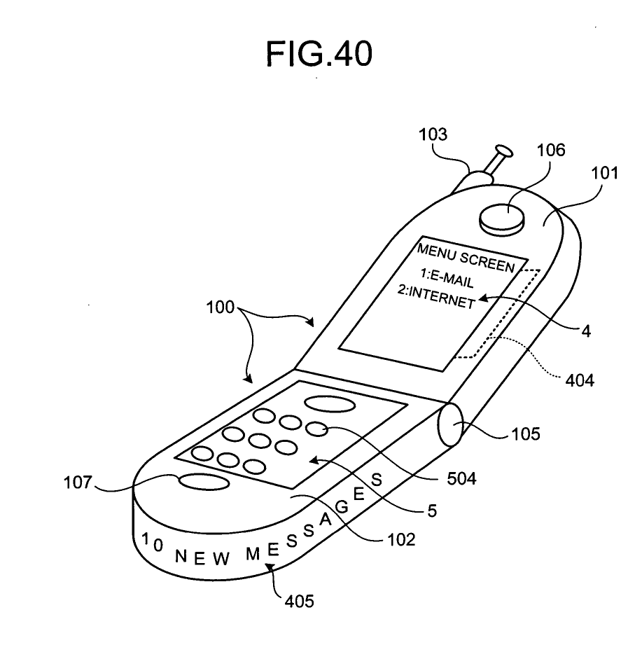

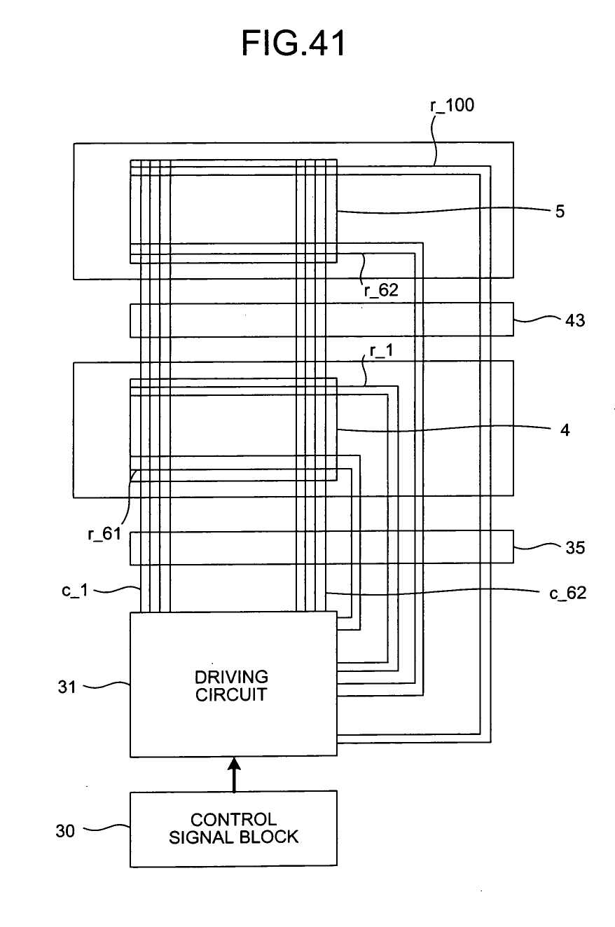

FIG. 39 is a schematic top plan view of display panels according to a fifteenth embodiment of the present invention, which are developed in plane. FIG. 40 is a perspective view of the display apparatus according to the fifteenth embodiment of the present invention, with the front cover of the display apparatus opened. Like configurations in the above embodiments are designated with like reference signs, and their explanations are omitted. As shown in FIG. 39, the display apparatus according to the fifteenth embodiment has a fourth display panel 405 including a seventh substrate 153 and an eighth substrate 154, which are opposite to each other, in addition to the configuration according to the fourteenth embodiment shown in FIG. 38. The fourth display panel 405 is connected to the first display panel 4 via the inter-panel FPC 43 (designated as “third inter-panel FPC 43”, for classification).

According to the fifteenth embodiment, although not particularly limited, among the source electrodes c_1 to c_100 of the first display panel 4, c_1 to c_60 are electrically connected to the source electrodes in the display area of the fourth display panel 405 via the inter-panel switching element 91 on the first substrate 1 (or the seventh substrate 153 of the fourth display panel 405) and electrodes (not shown) on the third inter-panel FPC 43. Similarly, among the gate electrodes r_1 to r_80 of the first display panel 4, r_30 to r_80 are electrically connected to the gate electrodes in the display area of the fourth display panel 405 via the inter-panel switching element 91 on the first substrate 1 (or the seventh substrate 153) and electrodes (not shown) on the third inter-panel FPC 43.

The four display panels 4, 5, 404, and 405 are mounted on a foldable portable telephone 100 as follows. As shown in FIG. 40, the first display panel 4 is mounted on an inner surface when the portable telephone cover 101 is folded, and displays communication contents, e-mail contents, Internet information, telephone numbers, remaining battery level, a receiving status, and necessary information for the user. The third display panel 404 is disposed on the back side of the first display panel 4 of the portable telephone cover 101, and displays an imaging status of an imaging element (not shown), e-mail received information, a receiving status, remaining battery level, and information about the portable telephone.

The second display panel 5 is mounted on an inner surface when the portable telephone main unit 102 is folded, and displays an input button image 504. The second display panel 5 is a resistive type of touch-panel. When the input button image 504 displayed on the second display panel 5 is touched, the same result as that obtained when the conventional button is pressed is obtained. In other words, according to the fifteenth embodiment, the portable telephone 100 does not have a physical input button. When the portable telephone 100 is opened, the input button image 504 is displayed on the second display panel 5. The fourth display panel 405 is mounted on the side surface of the portable telephone main unit 102 (or the portable telephone cover 101), although not particularly limited, and displays number of new e-mail messages and e-mail contents.

Based on the above configuration, in addition to the display contents of the first display panel 4, the second display panel 5, and the third display panel 404, different information is displayed on the fourth display panel 405, thereby increasing the amount of information that can be displayed. Therefore, this has an effect that the display apparatus can be used for various purposes. When the second display panel 5 has a function of displaying the input button image 504 in the manner that the user of the portable telephone 100 can easily handle, the convenience of the portable telephone improves. Specifically, when the user is accustomed to touching the input button image 504 with the thumb of the right hand (presses the button) while holding the portable telephone 100 in the right hand, the input button image 504 is displayed on the second display panel 5 near the thumb of the right hand. When the user is accustomed to touching the input button image 504 of the portable telephone 100 with the thumb of the left hand by holding the portable telephone 100 in the left hand, the input button image 504 can be displayed near the thumb of the left hand.

The present invention is not limited to the above embodiments, and can be variously modified. For example, in the above embodiments, a thin-film transistor made of an amorphous silicon (a-Si) film or a thin-film transistor made of a polysilicon film can be used for the thin-film transistor.

The configuration of the display panel according to the present invention can be naturally used for the active matrix liquid crystal display panel having a two-terminal switching element. For the two-terminal switching element, an MIM element, an amorphous silicon diode element, and a varistor element are available. Each pixel unit can be naturally provided with a two-terminal switching element, and a three-terminal switching element can be used for the inter-panel switching element. Each pixel unit can be naturally provided with a two-terminal switching element, and a three-terminal switching element can be used for the inter-panel switching element and the protection element. This similarly applies to the organic LED display panel.

In the first to the fifth embodiments, while the configuration of, the liquid crystal display apparatus (portable telephone) having the backlight unit is explained, a part of the present invention is effective for the configuration that employs a front illumination on the liquid crystal display panel of at least one of the first display panel 4 and the second display panel 5.

In the above embodiments, while the two display panels of the first display panel 4 and the second display panel 5 are explained, the driving circuit mounted on the first display panel 4 can drive more display panels. In other words, the inter-panel FPC that connects between the first display panel 4 and the second display panel 5 is employed between the second display panel 5 and the third display panel. Alternatively, the inter-panel FPC electrode that connects between the first display panel 4 and the third display panel is provided on the inter-panel FPC that is provided between the first display panel 4 and the second display panel 5.

According to the present invention, it is possible to obtain a display apparatus of which a display quality is satisfactory and power consumption is small and which has a protection against static electricity, without depending on the display contents of the first display panel or the display contents of the second display panel, and in which a driving circuit connected to the first display panel 4 drives the first display panel and the second display panel.

According to the present invention, it is possible to obtain a display apparatus in which the same driving circuit drives both display panels even when one is a liquid crystal display panel and another one is an organic LED display panel. According to the present invention, it is also possible to obtain a display apparatus in which the same driving circuit drives both display panels even when one is an active matrix display panel and another one is a passive matrix display panel.

Furthermore, the present invention can have the following characteristics (1) to (15).

(1) A display apparatus has a liquid crystal layer in a gap between a first substrate and a second substrate. A superimposed part of a display electrode provided on the first substrate and a counter electrode composed of a second electrode provided on the second substrate is a pixel unit. The display electrode is connected to a first electrode or a third electrode via a switching element. A first display panel is made of a liquid crystal display panel of which a first substrate is mounted with a driving circuit that applies a predetermined signal to the pixel unit, and a second display panel is made of a liquid crystal display panel having a liquid crystal layer in a gap between a third substrate and a fourth substrate, with a superimposed part of a display electrode provided on the third substrate and a counter electrode provided on the fourth substrate set as a pixel unit, and the display electrode being connected to a fourth electrode or a sixth electrode via a switching element. The fourth electrode or the sixth electrode of the second display panel is connected to the first electrode or the third electrode provided on the first substrate, via an inter-panel connector.

(2) A display apparatus has a liquid crystal layer in a gap between a first substrate and a second substrate. A superimposed part of a display electrode provided on the first substrate and a counter electrode composed of a second electrode provided on the second substrate is a pixel unit. The display electrode is connected to a first electrode or a third electrode via a switching element. A first display panel is made of a liquid crystal display panel of which a first substrate is mounted with a driving circuit that applies a predetermined signal to the pixel unit, and a second display panel is made of a liquid crystal display panel having a liquid crystal layer in a gap between a third substrate and a fourth substrate, with a superimposed part of a display electrode provided on the third substrate and a counter electrode provided on the fourth substrate set as a pixel unit, and the display electrode being connected to a fourth electrode or a sixth electrode via a switching element. The fourth electrode of the second display panel is connected to at least a part of the first electrode of the first display panel, via an inter-panel connector. The sixth electrode of the second display panel is connected to at least a part of the third electrode of the first display panel, via an inter-panel connector.

(3) A display apparatus has a liquid crystal layer in a gap between a first substrate and a second substrate. A superimposed part of a display electrode provided on the first substrate and a counter electrode composed of a second electrode provided on the second substrate is a pixel unit. The display electrode is connected to a first electrode or a third electrode via a switching element. A first display panel is made of a liquid crystal display panel of which a first substrate is mounted with a driving circuit that applies a predetermined signal to the pixel unit, and a second display panel is made of a liquid crystal display panel having a liquid crystal layer in a gap between a third substrate and a fourth substrate, with a superimposed part of a display electrode provided on the third substrate and a counter electrode provided on the fourth substrate set as a pixel unit, and the display electrode being connected to a fourth electrode or a sixth electrode via a switching element. The fourth electrode of the second display panel is connected to at least a part of the first electrode of the first display panel, via an inter-panel connector. The sixth electrode of the second display panel is connected to at least a part of the third electrode of the first display panel, via an inter-panel connector. The number of the fourth electrodes of the second display panel is larger than the number of the first electrodes of the first display panel. The number of the sixth electrodes of the second display panel is larger than the number of the third electrodes of the first display panel. A part of the fourth electrode and the sixth electrode from the driving circuit is connected to the second display panel without passing through the display area composed of the pixel unit of the first display panel.

(4) In (1) to (3) above, the first display panel and the second display panel are mutually superimposed, and the first substrate and the third substrate are disposed substantially in parallel.

(5) In (1) to (3) above, on the first substrate, a driving circuit connector that applies a predetermined signal to the driving circuit provided on the first substrate is provided.

(6) In (1) to (3) above, the driving circuit connector and the inter-panel connector are integrated.

(7) In (1) to (3) above, on at least one of the first substrate and the second substrate, an inter-panel switching element that controls supply of a signal to the second display panel is provided between the first electrode provided on the first display panel and the fourth electrode provided on the second display panel.

(8) In (1) to (3) above, on at least one of the first substrate and the second substrate, an inter-panel switching element that controls supply of a signal to the second display panel is provided between the first electrode provided on the first display panel and the fourth electrode provided on the second display panel. Further, on at least one of the first substrate and the second substrate, an inter-panel switching element that controls supply of a signal to the second display panel is provided between the third electrode provided on the first display panel and the sixth electrode provided on the second display panel.

(9) In (6) or (8) above, the switching element and a protection switching element that disperses static electricity generated in the electrodes are provided on the first substrate.

(10) In (1) to (3) above, at least one of the fourth electrode and the sixth electrode provided on the second substrate is connected from the driving circuit provided on the first substrate via a detour electrode that detours around the display area and the external periphery of the liquid crystal layer that constitute the first display panel.

(11) In (1) to (3) above, the driving circuit to be mounted on the first substrate is mounted on the first substrate according to a chip-on-glass mounting method.

(12) In (1) to (3) above, a backlight unit is provided between the first display panel and the second display panel.

(13) In (12) above, a backlight unit is provided between the first display panel and the second display panel, and one light guide constitutes the backlight unit.

(14) In (12) above, the light guide is adhered to at least one of the first display panel and the second display panel with an adhering member.

(15) The display apparatus has: a first display panel including a first electro-optic display medium, a first electrode-line group having plural electrode lines to apply a driving signal to the first electro-optic display medium, and an active element that controls supply of a driving signal to the first electro-optic display medium, a second display panel including a second electro-optic display medium, and a second electrode-line group having plural electrode lines to apply a driving signal to the second electro-optic display medium, and a connector that connects the first display panel and the second display panel. A part of or the whole electrode lines included in the second electrode-line group are connected to the electrode lines of the first electrode-line group via the connector.

### INDUSTRIAL APPLICABILITY

As explained above, the display apparatus according to the present invention is useful for driving a display apparatus having plural display panels with low power consumption. Particularly, the display apparatus is suitable for a display apparatus that is mounted on a portable telephone having plural display panels and portable information devices such as PDA.

1-15. (canceled)

16. A display apparatus comprising:
a first display panel including a first electro-optic display medium, a first electrode-line group having a plurality of electrode lines to supply a driving signal to the first electro-optic display medium, and an active element that controls supply of the driving signal to the first electro-optic display medium;
a second display panel including a second electro-optic display medium, and a second electrode-line group having a plurality of electrode lines to supply a driving signal to the second electro-optic display medium; and
a connecting member that connects the first display panel and the second display panel, wherein
at least a part of the electrode lines of the first electrode-line group are connected to a part or all of the electrode lines of the second electrode-line group via the connecting member.

17. The display apparatus according to claim 16, further comprising an inter-panel switching element that is provided between the electrode lines of the first display panel and the electrode lines of the second display panel that are connected to each other, and controls passage and non-passage of the driving signal.

18. The display apparatus according to claim 16, further comprising a protection switching element that is provided between the electrode lines of the first display panel and the electrode lines of the second display panel that are connected to each other, and disperses static electricity generated in the electrode lines.

19. The display apparatus according to claim 16, further comprising:
an inter-panel switching element that is provided between the electrode lines of the first display panel and the electrode lines of the second display panel that are connected to each other, and controls passage and non-passage of the driving signal; and
a protection switching element that is provided between the inter-panel switching element and the electrode lines of the second display panel, and disperses static electricity generated in the electrode lines.

20. The display apparatus according to claim 16, wherein a driving circuit that supplies the driving signal is connected to the first display panel.

21. The display apparatus according to claim 16, wherein a driving circuit that supplies the driving signal is connected to either of the first display panel and the second display panel, of which a display area is smaller.

22. The display apparatus according to claim 16, wherein a driving circuit that supplies the driving signal is connected to the connecting member that connects the first display panel and the second display panel.

23. The display apparatus according to claim 20, wherein a driving circuit that supplies the driving signal is connected using an anisotropic conductive-film made of an electric conductor and an adhesive.

24. The display apparatus according to claim 21, wherein a driving circuit that supplies the driving signal is connected using an anisotropic conductive-film made of an electric conductor and an adhesive.

25. The display apparatus according to claim 22, wherein a driving circuit that supplies the driving signal is connected using an anisotropic conductive-film made of an electric conductor and an adhesive.

26. The display apparatus according to claim 17, wherein
the first display panel and the second display panel are operated with different driving signals, and
the inter-panel switching element includes a signal converting circuit that converts a driving signal for the first display panel into a driving signal for the second display panel.

27. The display apparatus according to claim 19, wherein
the first display panel and the second display panel are operated with different driving signals, and
the inter-panel switching element includes a signal converting circuit that converts a driving signal for the first display panel into a driving signal for the second display panel.

28. The display apparatus according to claim 17, wherein
the first display panel is an active-matrix liquid-crystal-display panel,
the second display panel is a passive-matrix liquid-crystal-display panel, and
the inter-panel switching element includes a signal converting circuit that converts a driving signal for the first display panel into a driving signal for the second display panel.

29. The display apparatus according to claim 19, wherein
the first display panel is an active-matrix liquid-crystal-display panel,
the second display panel is a passive-matrix liquid-crystal-display panel, and
the inter-panel switching element includes a signal converting circuit that converts a driving signal for the first display panel into a driving signal for the second display panel.

30. The display apparatus according to claim 17, wherein
the first display panel is an active-matrix liquid-crystal-display panel,
the second display panel is formed with an organic light-emitting diode, and
the inter-panel switching element includes a signal converting circuit that converts a driving signal for the first display panel into a driving signal for the second display panel.

31. The display apparatus according to claim 19, wherein
the first display panel is an active-matrix liquid-crystal-display panel,
the second display panel is formed with an organic light-emitting diode, and
the inter-panel switching element includes a signal converting circuit that converts a driving signal for the first display panel into a driving signal for the second display panel.

32. The display apparatus according to claim 17, wherein
the first display panel is an active-matrix display panel formed with an organic light-emitting diode,
the second display panel is a passive-matrix liquid-crystal-display panel, and
the inter-panel switching element includes a signal converting circuit that converts a driving signal for the first display panel into a driving signal for the second display panel.

33. The display apparatus according to claim 19, wherein
the first display panel is an active-matrix display panel formed with an organic light-emitting diode,
the second display panel is a passive-matrix liquid-crystal-display panel, and
the inter-panel switching element includes a signal converting circuit that converts a driving signal for the first display panel into a driving signal for the second display panel.

34. The display apparatus according to claim 17, wherein
the first display panel is an active-matrix display panel formed with an organic light-emitting diode,
the second display panel is an active-matrix liquid-crystal-display panel, and
the inter-panel switching element includes a signal converting circuit that converts a driving signal for the first display panel into a driving signal for the second display panel.

35. The display apparatus according to claim 19, wherein
the first display panel is an active-matrix display panel formed with an organic light-emitting diode,
the second display panel is an active-matrix liquid-crystal-display panel, and
the inter-panel switching element includes a signal converting circuit that converts a driving signal for the first display panel into a driving signal for the second display panel.

36. The display apparatus according to claim 16, further comprising:
a third display panel including a third electro-optic display medium, and a third electrode-line group having a plurality of electrode lines to supply a driving signal to the third electro-optic display medium; and
a second connecting member that connects the third display panel with either of the first display panel and the second display panel, wherein
a part or all of the electrode lines of the third electrode-line group are connected to the electrode lines of the first electrode-line group or the electrode lines of the second electrode-line group via the second connecting member.

37. The display apparatus according to claim 36, further comprising:
a fourth display panel including a fourth electro-optic display medium, and a fourth electrode-line group having a plurality of electrode lines to supply a driving signal to the fourth electro-optic display medium; and
a third connecting member that connects the fourth display panel with one of the first display panel, the second display panel, and the third display panel, wherein
a part or all of the electrode lines of the fourth electrode-line group are connected to the electrode lines of the first electrode-line group, the electrode lines of the second electrode-line group, or the electrode lines of the third electrode-line group via the third connecting member.
